(19) United States
(12) Patent Application Publication
(10) Pub. No.: US 2024/0215579 A1
(43) Pub. Date: Jul. 4, 2024

(54) USE OF ANTI-CLOTTING COMPOUNDS AS RODENTICIDES

(71) Applicant: Dietrich GULBA, Essen (DE)

(72) Inventor: Dietrich GULBA, Essen (DE)

(21) Appl. No.: 18/285,746

(22) PCT Filed: Apr. 5, 2022
(86) PCT No.: PCT/EP2022/059011

§ 371 Date: Oct. 5, 2023

(30) Foreign Application Priority Data
Apr. 6, 2021 (EP) 21166946.0

(51) Int. Cl. A01N 43/54; A01N 37/34; A01N 43/08; A01N 43/16; A01N 43/42; A01N 43/653; A01N 43/78; A01P 11/00

(52) U.S. Cl. CPC A01N 43/54; A01N 37/34; A01N 43/08; A01N 43/16; A01N 43/42; A01N 43/653; A01N 43/78; A01P 11/00

(57) ABSTRACT

The present invention proposes a composition for controlling pest rodents, the composition comprising: a) at least one direct coagulation factor inhibitor and b) at least one P-glycoprotein inhibitor (p-GP inhibitor). Through the composition, it is possible to achieve that existing resistances in pest rodents can be circumvented and at the same time a good effect can be achieved with a lower dosage, which can result in a comparatively more environmentally friendly application.

### TECHNICAL FIELD

The present invention relates to a composition for controlling pest rodents, to a use of the composition as rodenticide, to a pest rodent bait containing the composition, and to a method for controlling pest rodents.

### BACKGROUND

Compositions for controlling pest rodents are known per se. Wild rodents have long been a considerable problem for human health, property and food supply. Even as far back as the pharaonic period, cats were used against rodents. Just taking the rat as an example, almost 70 diseases are know, many of which can be transmitted to humans, such as bubonic plague, typhoid fever or Weil's disease. Wild rodents constitute an economic threat in agriculture. Economic harm is caused not only by their consumption of feed or food but also, above all, by contamination by droppings and urine. It is estimated that approximately 10% of the global food supply is consumed or damaged by rats alone. Livestock diseases such as foot-and-mouth disease or swine fever are also transmitted by wild rodents. In addition, further damage is also inflicted on buildings and equipment, since wild rodents can also, for example, damage water and wastewater pipes, and cables.

The most widespread method for controlling such pest rodents is the use of edible bait—in some cases, storerooms and/or underground rodent tunnels are also fumigated. There are specific requirements on suitable active ingredients for edible bait. Rats live in groups, exhibit distinctive social behavior and have a good memory. Young males volunteer to be food tasters, while the other rats wait for the next few hours. If the food taster dies within two days because it has eaten poisoned bait, their conspecifics no longer touch the bait. An active ingredient suitable as rodenticide therefore has to exhibit a correspondingly delayed onset of action, such that conspecifics of the food taster are not deterred from consuming a corresponding bait. The rodenticides used currently for edible bait are customarily anticoagulants, since zinc phosphide, typically used in earlier times in poisoned wheat, arsenic compounds, barium carbonate. strychnine and white phosphorus have not been authorized as rodenticides for some time.

In hemostasis, platelets first adhere to tissue structures, aggregate together and form a hemostatic plug. The aggregation of platelets to one another is mediated by the binding of fibrinogen and Ca²⁺ to receptors on the platelets. In the secondary phase, the fibrin formation phase, the fibrin formed strengthens the hemostatic plug. Actual blood clotting is therefore the conversion of soluble fibrinogen to insoluble fibrin. The activation of blood clotting results in a prothrombinase complex composed of factor Xa factor Va. phospholipid and Ca²⁺. The key enzyme in blood clotting is the protease thrombin. Thrombin catalyzes the conversion of fibrinogen to fibrin by cleaving the fibrinopeptides A and B from the fibrinogen. The resulting fibrin monomers aggregate to form polymers.

For poisoning rodents, such as rats, mice, voles, rabbits, opposums and ground squirrels, use has to date been made, inter alia, of warfarin, coumatetralyl, diphacinone, flocoumafen. brodifacoum and bromadiolone. Warfarin is (RS)-4-hydroxy-3-(3-oxo-1-phenylbutyl)coumarin, and coumatetralyl is 4-hydroxy-3-(1,2,3,4-tetrahydro-1-naphthyl)coumarin. Difenacoum is 3-(3-biphenyl-4-yl-1,2,3,4-tetrahydro-1-naphthyl)-4-hydroxycoumarin, flocoumafen is 4-hydroxy-3-[3-(4′-trifluoromethylbenzyloxyphenyl)-1,2,3,4-tetrahydro-1-naphthyl]coumarin, brodifacoum is 3-(3-(4′-bromo-1,1′-biphenyl-4-yl)-1,2,3,4-tetrahydro-1-naphthyl)-4-hydroxycoumarin, bromadiolone is 3-[3-(4′-bromobiphenyl-4-yl)-3-hydroxy-1-phenylpropyl]-4-hydroxycoumarin. Therefore, these are coumarins. Coumarins. derivatives of 4-hydroxycoumarin or 1,3-indanedione, are vitamin K antagonists because they block the enzymes vitamin K quinone reductase and vitamin K epoxide reductase.

Vitamin K is required as a cofactor for the post-translational γ-carboxylation of N-terminal glutamic acid residues in a number of proteins also including clotting factors II, VII, IX and X and also the clotting modulators protein C and protein S. Coumarins, for example phenprocoumon (Marcumar®, Falithrom®) or warfarin (Couxnadin®) are therefore indirectly-acting anticoagulants. According to the different biological half-lives of vitamin K-dependent clotting factors, the maximum coumarin effect manifests only after a considerable delay; in humans, this is 24 to 36 hours.

Two further known rodenticides are difenacoum (2-(diphenylacetyl)-1H-indene-1,3(2H)-dione) and pindone (2-pivaloyl-1,3-indanedione). As indanedione compounds, they act as vitamin K antagonists, like a coumarin.

The efficacy of coumarins and indanedione compounds is based on the slow accumulation of the substance in the animal's body and on the resulting increase in clotting inhibition, as a result of which the animals suffer internal bleeding. It is precisely this gradual-onset poisoning effect which made coumarins and indanedione compounds so particularly successful as pest rodent poisons.

When consuming bait filled with a coumarin or indanedione compound. the rats initially remain alive, and do not exhibit any symptoms of poisoning. A wild rodent such as a rat which feeds regularly on the baited food therefore does not die directly or shortly after consuming the bait, and rather remains alive for a few days before ultimately bleeding internally. This therefore also applies to a “food taster rat”. The protective social behavior of rats is therefore effectively circumvented and the food bait containing the pesticide (coumarin/indanedione) is not avoided by the rat population. In fact, the entire rat population feed from the readily available bait, which leads, albeit with a delay, to the complete extinction of the entire rat population. Regularly offered bait containing a coumarin or indanedione compound has therefore reliably led to the ensured extinction of large populations of rats.

Meanwhile, because of the widespread use of coumarin and indanedione compounds, it is to be expected that almost a third to a half of all rat strains worldwide have developed marked resistance to coumarin and indanedione compounds. This resistance is based on an alternative pathway to the reduction of vitamin K, which is also present and is dependent on thiol (SH—)/disulfide (S—S). Unlike in humans, where the thiol-dependent reduction pathway is generally only insufficiently developed, there are currently a number of rat strains which can activate this alternative vitamin K reduction pathway. Where coumarins have been used for long periods as pesticides, the thiol-dependent reduction pathway held a significant selective advantage for rats. Over the many decades during which coumarin bait has been used highly efficiently, coumarin-resistant strains in particular have been able to reproduce undisturbed, such that during this time there has been considerable selection for this coumarin-resistant strain.

A significant problem of such anticoagulants is therefore, in addition to persistence and/or bioaccumulation, widespread resistance in wild rodents. Resistance to an anticoagulant was found as early as the 1950s. Initially, only first-generation anticoagulants such as warfarin and coumatetralyl were affected, but resistance to more effective second-generation anticoagulants such as difenacoum or bromadiolone was also observed later. Since then, more than 40% of all rat strains are resistant to these anticoagulants.

Moreover, since 1 Jan. 2013, the selling of conventional rodenticides in the European Union was actually supposed to be no longer authorized due to the concentration in the environment exceeding the level predicted to be harmless to organisms. However, due to the lack of alternatives, competent professionals are still authorized to use them for the time being.

There is therefore a need for an effective way to control wild rodents.

### OBJECT

Therefore, the object of the present invention is to provide a composition for controlling pest rodents that overcomes the disadvantages of known compositions. In particular, the object of the present invention is to provide compositions for controlling pest rodents that circumvent resistance to known vitamin K antagonists in order to have high efficacy and comparatively low environmental impact.

This object is solved by the composition according to claim 1 and also by the use according to claim 12, the pest rodent bait according to claim 13 and the method according to claim 14. Preferred configurations of the invention are given in the dependent claims and in the description, it being possible for further features shown in the dependent claims or in the description to constitute, individually or in any desired combination, a subject of the invention, unless clearly shown otherwise from the context.

### DEFINITIONS

Unless otherwise specified. the following terms and expressions, when used in this document including the description and the claims, have the following meanings.

The term “aliphatic” as used in this document can relate both to a chemical group and to a chemical compound as a whole, depending on the context. The term means, unless otherwise indicated, that a straight-chain or branched hydrocarbon chain is present, which may be saturated, monounsaturated or polyunsaturated and may contain one or more heteroatoms. Heteroatoms are atoms other than carbon, such as N, O, S, Se or Si. An unsaturated aliphatic group contains one or more double and/or triple bonds, i.e. alkene and/or alkyne groups. The branches of the hydrocarbon chain can have linear chains and also non-aromatic cyclic elements. Unless otherwise indicated. the hydrocarbon chain can have any desired length and any desired number of branches. In typical embodiments, the hydrocarbon main chain contains up to approximately 20 carbon atoms, for example 1 to approximately 15 carbon atoms. In some embodiments, the hydrocarbon main chain has 2 to approximately 10 carbon atoms. Examples of alkyl groups are methyl, ethyl, propyl, butyl, pentyl, hexyl, heptyl, octyl (caprylyl), nonyl (pelargonyl), decyl (capryl), dodecyl (lauryl), tetradecyl (myristyl), hexadecyl (cetyl), the n-isomers of these groups, isopropyl, isobutyl, isopentyl, sec-butyl, tert-butyl, neopentyl or 3,3-dimethylbutyl.

The term “cycloaliphatic”, equivalent to “alicyclic”, relates, unless otherwise indicated, to a non-aromatic cyclic chemical structure, typically a cyclic hydrocarbon radical. Such a ring structure can be saturated. Such a ring structure can contain one or more double bonds. This cyclic structure can contain a plurality of closed rings, which can for example be fused into decalin. A cycloaliphatic group and a cycloaliphatic molecule can be substituted with one or more non-aromatic rings, chain elements or functional groups. If a cycloaliphatic structure is substituted with an aromatic, this group or this molecule is also referred to as arylalicyclic. Unless otherwise indicated, the main chain of a cycloaliphatic hydrocarbon unit can have any desired number of non-aromatic rings or chain elements in a ring. In some embodiments, a main chain of a cycloaliphatic hydrocarbon unit can have 3, 4, 5, 6, 7 or 8 main chain atoms in a ring. Illustrative examples of such units are cyclopentyl, cyclohexyl, cycloheptyl or cyclooctyl. A cycloaliphatic hydrocarbon unit can furthermore have heteroatoms. both within the main chain and in substituents such as a side chain or a cyclic substituent. Examples of such heteroatoms are N, O, S, Se or Si.

The term “aromatic” as used in this document relates to a planar cyclic hydrocarbon unit, both as a complete molecule and also as a chemical group or radical. An aromatic hydrocarbon unit is characterized by conjugated double bonds. An aromatic unit can have a single ring or a plurality of fused or covalently bonded rings. Illustrative examples of corresponding units are cylcopentadienyl, phenyl, naphthalenyl, [10]annulenyl-(1,3,5,7,9-cyclodecapentaenyl), [12]annulenyl, [8]annulenyl, phenalene (perinaphthene), 1,9-dihydropyrene or chrysene (1,2-benzophenanthrene). An individual aromatic ring typically has 5, 6, 7 or 8 main chain atoms. An aromatic unit can contain substituents such as functional groups or aliphatic groups. The term “aromatic” also covers “arylalkyl”, for instance a benzyl unit. An aromatic hydrocarbon unit can furthermore have heteroatoms, both within the main chain and in substituents, for instance a side chain. Examples of such heteroatoms are N, O, S or Se. Examples of heteroaromatic hydrocarbon units include furanyl, thiophenyl, naphthyl, naphthofuranyl, anthrathiophenyl, pyridinyl, pyrrolyl, quinolinyl, naphthoquinolinyl, quinoxalinyl, indolyl, benzindolyl, imidazolyl, oxazolyl, oxoninyl, oxepinyl, benzoxepinyl, azepinyl, thiepinyl, selenepinyl, thioninyl, azecinyl (azacyclodecapentaenyl), diazecinyl, azacyclododeca-1,3,5,7,9,11-hexaen-5,9-diyl, azozinyl, diazocinyl, benzazocinyl, azecinyl, azaundecinyl, thia[11 ]annulenyl, oxacyclotrideca-2,4,6,8,10,12-hexaenyl or triazaanthracenyl units.

The term “arylaliphatic” relates to hydrocarbon units containing one or more aromatic units and one or more aliphatic units, with one or more aromatic units being bonded to one or more aliphatic units. In some embodiments, a hydrocarbon main chain contains 5, 6, 7 or 8 main chain atoms in one aromatic ring of an arylaliphatic unit. Examples of arylaliphatic units include 1-ethylnaphthaline, 1,1′-methylenebisbenzene, 9-isopropylanthracene, 1,2,3-trimethylbenzene, 4-phenyl-2-buten-1-ol, 7-chloro-3-(1-methylethyl)-quinoline, 3-heptylfuran, 6-[2-(2,5-diethylphenyl)ethyl]-4-ethyl-quinazoline or 7,8-dibutyl-5,6-diethylisoquinoline.

The terms “control” and “controlling” as used in this document relate to a measure which succeeds in killing an unwanted organism, in the present case a pest rodent. In some embodiments, “control” has a meaning that corresponds to “combating”. “Control” and “controlling” denote for example causing, accelerating, promoting, including enabling, an abnormal, including pathological, state to arise in an organism of a pest rodent. Typically, “controlling” includes a method and/or a use in which a compound is administered to cells or tissue of a pest rodent. The terms “control” and “controlling” also generally include elements of the method and/or the use which make it possible to administer a corresponding compound to cells or tissue of a pest rodent. In the method and uses disclosed here, such elements that enable administration typically relate to the time frame of the onset of action of the active ingredient used in such a method and/or such a use.

The expression “consisting of” as used in this document means including, and limited to. what follows the term “consisting of”. The term “consisting of” thus indicates that listed elements are required or necessary, and that no other elements may be present. The term “substantially consisting of” is accordingly understood to mean that any elements defined following this expression are included, and that further elements may also be present, for example in a sample or a composition, which further elements do not change the activity or effect stated in this document for the elements in question, i.e. do not impair them or contribute to them. As an example, this term means, for a pharmaceutical composition, that it can contain carrier substances/auxiliaries when they substantially consist of one or more active ingredients. Thus, the expression “substantially consisting of” indicates that the defined elements are necessary or required, but that further elements are optional and may or may not be present, depending on whether or not they are of relevance to the effect or efficacy of the defined elements.

The word “approximately”, when used herein, relates to a value that is within an acceptable error range for a given value as determined by a person of average skill in the art. This will in part depend on how the value in question has been determined or measured, i.e. on the limitations of the measurement system. “Approximately” can for example mean within a standard deviation of 1 or more, depending on the use in the field in question. The term “approximately” is also used to indicate that the amount or value can be the value given, or can be another value which is roughly the same. The term is intended to express the idea that similar values favor equivalent results or effects as disclosed in this document. In this context, “approximately” can relate to a range of up to 10% above and/or below a specific value. In some embodiments, “approximately” relates to a range of up to 5% above and/or below a specific value, such as approximately 2% above and/or below a specific value. In some embodiments, “approximately” relates to a range of up to 1% above and/or below a specific value. In some embodiments, “approximately” relates to a range of up to 0.5% above and/or below a specific value. In one embodiment, “approximately” relates to a range of up to 0.1% above and/or below a specific value.

The conjunction “and/or” between several elements, when used herein, is considered to cover both individual and combined options. If, for example, two elements are linked by “and/or”, a first option relates to the use of the first element without the second. A second option relates to the use of the second element without the first. A third option relates to the use of the first and second elements together. It is understood that any one of these options falls under the meaning of the expression, and therefore meets the conditions of the term “and/or” as used in this document.

The term “low-molecular-weight” in conjunction with a compound, for example a low-molecular-weight thrombin inhibitor, relates to a molecular mass in the range up to approximately 5000 Da. In some embodiments, the mass of a low-molecular-weight compound can be in the range up to approximately 2000 Da.

The term “prodrug” denotes a compound which is converted—for example enzymatically, mechanically and/or electromagnetically—into its active form in the body of an animal, for instance a rodent, this active form exhibiting the desired pharmacological or toxicological effect. A “prodrug” is accordingly a derivative of the active ingredient that itself is still pharmacologically/toxicologically inactive or has a lesser effect than the final active ingredient. Prodrugs are typically used to deal with requirements regarding stability, specificity, toxicity or bioavailability. A prodrug can, for example. have an advantageous solubility, tissue compatibility or release compared to the final active ingredient. For example, compared to the final active ingredient, a prodrug can bear a protective group on a functional group, which protective group is removed in vivo by solvolysis or enzymatically. As a further example, a prodrug can be converted in vivo into a final active ingredient by oxidation and/or phosphorylation or glycosylation. One or more enzymes and/or gastric acids may be involved in this. Examples of typical prodrugs include carboxylic acid derivatives such as an ester, which is obtained by reacting a parent acid compound with a suitable alcohol, for example a C₁₋₆ alcohol, an amide, which is obtained by reacting a parent acid compound with a suitable amine, for example a C₁₋₆ amine, or an acylated basic group, for example a C₁₋₆ acylamine, which is obtained by reacting a base-containing parent compound with a carboxylic acid compound.

The term “administering” or “administration”, when used herein, relates to any manner of transferring, supplying, introducing or transporting material such as a compound, for example a pharmaceutical compound, or another reagent such as an antigen, into or to a subject. Administration forms include for example oral administration, topical (local) contact, intravenous, intraperitoneal, intramuscular, intranasal and subcutaneous administration. In the applications and methods described herein, the administration to rodents is typically oral. Administration “in combination with” one or more further substances, for instance one or more pharmaceutical active ingredients, covers simultaneous and sequential administration, in any order. When laying bait as administration, the social behavior of rodents is taken into account insofar as the rodents are left to choose the time and order of ingestion within the group.

Singular forms such as “an”, “a” or “the” include the plural form when used in this document. Thus, for example, reference to “a cell” denotes both an individual cell and also a plurality of cells. In some cases, the expression “one or more” is explicitly used in order to indicate, in the case in question, that the singular form also includes the plural form. Such explicit references do not restrict the general meaning of the singular form. Unless otherwise indicated, the term “at least”, when preceding a sequence of elements, is understood accordingly to mean that it relates to each of these elements. The terms “at least one” or “at least one of” include for example one, two, three, four or more elements.

The expression “at least substantially consisting of”, when used herein, is considered to cover the terms “substantially consisting of” and “consisting of”. The term “at least substantially consisting of” thus indicates that, in some embodiments, listed elements are required or necessary, and that no other elements may be present. Thus, the term “at least substantially consisting of” also indicates that, in some embodiments, listed elements are required or necessary, but that further elements are optional and may or may not be present, depending on whether or not they are of relevance to the effect or efficacy of the defined elements. It is furthermore understood that minor deviations above or below a range stated herein can be used to achieve substantially the same result as a value that lies within that range. Unless otherwise indicated, the disclosure of a range is also provided as a continuous range, including all individual values that lie between the minimum and maximum values.

The formulae described in the context of the present invention should therefore be understood such that it can also be provided that the described substances can be present in the composition as prodrug, salt or hydrate.

### DESCRIPTION OF THE INVENTION

The invention proposes a composition for controlling pest rodents, having:
a) at least one direct clotting factor inhibitor, and
b) at least one P-glycoprotein inhibitor (Pgp inhibitor), wherein the P-glycoprotein inhibitor (Pgp inhibitor) is at least one compound selected from the group consisting of amiodarone, dronedarone, diltiazem, verapamil, atorvastatin, rosuvastatin, lovastatin, simvastatin, clarithromycin, roxithromycin, erythromycin, moxifloxacin, ofloxacin, fluconazole, voriconazole, itraconazole, mefloquine, quinidine, ritonavir, nefinavir, saquinavir, elacridar, tamoxifen, cyclosporin, tacrolimus, ciclosporin, lansoprazole, omeprazole and ondansetron.

In the context of the present invention, a clotting factor inhibitor means a substance that can inhibit blood clotting factors. In the context of the present invention, blood clotting factors are substances involved in functioning blood clotting. In the context of the present invention, inhibition means restricting the function of the corresponding substance, the term being used independently of the mechanism of action of the inhibitor. In the context of the present invention, an inhibitor can therefore for example be a true inhibitor or also an antagonist. In the context of the present invention, direct clotting factor inhibitors are clotting factor inhibitors which directly inhibit the clotting factors and which, in comparison to indirect clotting factor inhibitors such as vitamin K antagonists, do not require cofactors or for example only inhibit the synthesis of the clotting factors.

In the context of the present invention, a P-glycoprotein inhibitor means a substance that restricts the function of P-glycoprotein. The term P-glycoprotein means, in a known way, a specific membrane protein which is a primary efflux pump which can transport its substrate out of the cell membrane and into the extracellular space. P-glycoprotein inhibitors are also referred to as multidrug resistance protein (MDRP) or MDR1, breast cancer resistance protein (BCRP), or ATP-binding cassette (ABC) superfamily.

It was possible to demonstrate that pest rodents could be killed by the above-described composition. In particular, it was possible to demonstrate that, by combining at least one clotting factor inhibitor, at a dosage which causes absolutely no bleeding in rats when administered acutely or chronically, with at least one P-glycoprotein inhibitor which on its own has no hemorrhagic effect whatsoever, it is possible to increase the effect of the abovementioned clotting factor inhibitor such that, even at a comparatively low consumption of the composition by a pest rodent, a clotting cascade can be inhibited in such a way as to induce, after a latency period, the death of the pest rodent by spontaneous bleeding.

Advantageously, it was possible to demonstrate that the efficacy of the composition according to the invention is effective even in rat strains which potentially have resistance to vitamin K antagonists.

Without being bound by a theory, it was possible to demonstrate that the direct clotting factor inhibitors are all subject to a ceiling effect, which is why even with excessive dosing when consumed orally, only limited concentrations can be reached in the blood which are insufficient to cause spontaneous bleeding. The combination with at least one Pgp inhibitor makes it possible to suppress this ceiling effect. In addition, the Pgp inhibitor makes it possible for the direct clotting factor inhibitors used to cross the blood-brain barrier and thus to also become active in the brain. This makes it possible to also cause spontaneous bleeding on the brain in a delayed manner, thereby achieving particularly rapid death of the pest rodent without any manifestations of poisoning appearing beforehand. Symptoms of poisoning or the death of a rat shortly after a rat has eaten bait can cause a rat strain to completely avoid this bait and therefore escape extermination. Furthermore, some Pgp inhibitors are also inhibitors of the various cytochrome oxidases. Cytochrome oxidases are responsible for degrading some drugs in the liver. Blocking cytochrome P450 (CYP) monooxygenase prolongs degradation and thus the half life of the dependent drugs. As a result, it is also possible to achieve more rapid accumulation of the constituents of the composition when the composition is ingested multiple times, and therefore a lethal dose can be achieved even with low repeated ingestion. When selecting a Pgp inhibitor with CYP inhibition, the degradation of the substance(s) is accordingly also inhibited, as a result of which the level increases further.

The fact that the composition has the at least one direct clotting factor inhibitor and the at least one Pgp inhibitor makes it possible to achieve a good rodenticide effect at a low dosage of the clotting factor inhibitor.

The above-described composition further makes it possible to achieve better environmental compatibility. This can advantageously be achieved because the efficacy of the composition is based on the combination of the direct clotting factor inhibitor with the at least one Pgp inhibitor. The concentration of the direct clotting factor inhibitor can therefore be kept low enough that a lethal effect can only be achieved by combination with the Pgp inhibitor. Because each of the at least two substances are metabolized very differently and also excreted differently, the composition of the active substances administered together changes by the concentration of each of the individual substances changing such that the toxic effect is rapidly lost, and even the excreta from such an animal no longer contain any toxic composition. Because the composition is so effective, the dose of the composition can also be selected such that it only begins after being ingested multiple times. Thus, the effect in animals which accidentally consume the bait in question can be reduced. Furthermore, the substances used are metabolized differently in the target animal, and therefore toxicity is rapidly lost for predators and scavengers, and also the excreta from the target animals no longer contain an active combination of the constituents of the composition. As a result, the composition may be safer to handle and have less of an environmental impact due to an overall lower dose. In particular, the poison effect for predators of the poisoned pest rodents is already weakened by metabolism by the pest rodent, because the pest rodent stays alive for a while after ingestion. Thus, carcasses of poisoned pest rodents also have a weakened poison effect for scavengers. Remaining poison can also be rapidly further degraded by the predators or scavengers, rapidly further reducing toxicity for said predators and scavengers. Furthermore, a lethal effect for predators and scavengers can only occur if they simultaneously eat several poisoned animals in succession on successive days. In particular, this reduces cross-toxicity for other animals.

As a result, therefore, the composition according to the invention makes it possible to effectively control pest rodents and at the same time ensure comparatively lower cross-toxicity for other animals and a comparatively very low impact on the environment.

Preferably, it can be provided that the clotting factor inhibitor is selected from the group consisting of factor Xa inhibitors and factor IIa inhibitors.

This makes it possible to achieve a particularly efficient composition. Without being bound to a theory, it is assumed that factor Xa inhibitors and factor IIa inhibitors are particularly efficient because their efficacy can be particularly advantageously influenced by the Pgp inhibitor and because they both inhibit each of the end sections of the intrinsic and also the extrinsic clotting cascade.

### Factor Xa Inhibitors

It can preferably be provided that the composition has at least one factor Xa inhibitor as clotting factor inhibitor, wherein the at least one factor Xa inhibitor is preferably selected from the group consisting of the following listed factor Xa inhibitors i)-ix).

It was possible to demonstrate that these factor Xa inhibitors are particularly well suited to the composition because they can be particularly advantageously influenced by the Pgp inhibitor and are well suited for oral consumption.

In a preferred configuration, it can be provided that the factor Xa inhibitor is selected from
i) a compound of the following formula:

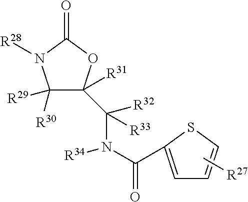

wherein R²⁷ is halogen, cyano, nitro, amino, aminomethyl, C₁₋₈ alkyl, C₃₋₇ cycloalkyl, C₁₋₈ alkoxy, imidazolinyl, —C(═NH)NH₂, carbamoyl or mono- and di-(C₁₋₄)-alkylaminocarbonyl, and

R²⁸, R²⁹, R³⁰, R³¹, R³², R³³ and R³⁴ are, independently of one another, H or C₁₋₆ alkyl.

For example, the above-described factor Xa inhibitor can preferably be rivaroxaban (Xarelto®), for example as also described in WO 01/47919.

In an alternative preferred configuration, it can be provided that the factor Xa inhibitor is selected from
ii) a compound of the following formula:

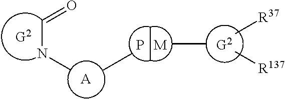

wherein A is a C₃-C₁₀ carbocycle or a 5-12-membered heterocycle composed of carbon atoms and 1-4 heteroatoms N, O or S,

P is a 5-7-membered carbocycle or a 5-7-membered heterocycle composed of carbon atoms and 1-3 heteroatoms N, O or S, and contains 0-3 double bonds in the ring,

M is a 3-10-membered carbocycle or a 4-10-membered heterocycle composed of carbon atoms and 1-3 heteroatoms N, O or S,

G¹ is phenyl, pyridyl, pyrimidyl, pyrazinyl or pyridazonyl,

G² is a 4-8-membered monocyclic or bicyclic hydrocarbon ring having 0 to 2 C═C double bonds, and

R³⁷ and R¹³⁷ are, independently of one another, H, —OH, F, Cl, Br, I, CN, C₁-C₄ alkyl, OCH₃, OCH₂CH₃, OCH₂CH₂CH₃, O(CH₃)₂, OCF₃ or amino.

For example, the above-described factor Xa inhibitor can preferably be apixaban (Eliquis®), for example as described in US 2003/191115.

In an alternative preferred configuration, it can be provided that the factor Xa inhibitor is selected from
iii) a compound of the following formula:

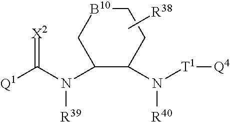

wherein Q¹ is a saturated or unsaturated 5- or 6-membered hydrocarbon ring, a saturated or unsaturated 5-7-membered heterocyclic group, a saturated or unsaturated bicyclic or tricyclic fused hydrocarbon group or a saturated or unsaturated bicyclic or tricyclic fused heterocyclic group,

B¹⁰ is N or CH₂,

X² is O or S,

R³⁸ is H, OH, alkoxy, alkyl, alkenyl, alkynyl, halogen, CN, amino, aminoalkyl, acyl, acylamino, carbamoyl, aryl or aralkyl,

R³⁹ and R⁴⁰ are, independently of one another, H, OH, an alkyl group or an alkoxy group,

Q⁴ is an aryl group, an arylalkenyl group, an arylalkynyl group, a heteroaryl group, a heteroarylalkenyl group, a saturated or unsaturated bicyclic or tricyclic fused hydrocarbon group or a saturated or unsaturated bicyclic or tricyclic fused heterocyclic group, and

T¹ is a carbonyl group, a sulfonyl group, —C(═O)—C(═O)—, —C(═O)—C(═O)—NH—,

—C(═O)—C(═O)—N(alkyl)-, —C(═O)—(C₁₋₅ alkylene)-N(alkyl), —C(═O)—(C₁₋₅ alkylene)-NH—, —C(═O)—(C₁₋₅ alkylene)-C(═O)— or —C(═O)—N═N.

For example, the above-described factor Xa inhibitor can preferably be edoxaban (Lixiana®), as described in EP 2 343 290 or PE 2 374 456.

In an alternative preferred configuration, it can be provided that the factor Xa inhibitor is selected from
iv) a compound of the following formula:

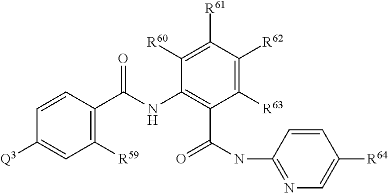

wherein Q³ is:

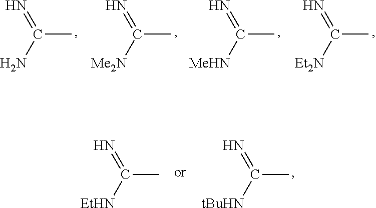

R⁵⁹ is H, F, Cl or Br,

R⁶⁰, R⁶¹, R⁶² and R⁶³ are, independently of one another, H, F, Cl, Br, Me, NO₂, OH, OMe, NH₂, NHAc, NHSO₂Me, CH₂OH or CH₂NH₂, and

R⁶⁴ is F, Cl, Br, Me, OH or OMe.

For example, the above-described factor Xa inhibitor can preferably be betrixaban (N-(5-chloropyridin-2-yl)-2-([4-(N,N-dimethylcarbamimidoyl)benzoyl]amino)-5-methoxybenzamide), for example as described in WO 01/64642 and WO 01/64643.

In an alternative preferred configuration, it can be provided that the factor Xa inhibitor is selected from
v) a compound of the following formula:

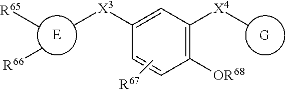

wherein E is a benzene ring or a 5- or 6-membered heterocycle having 1 to 4 heteroatoms N, S or O,

G is a piperidine ring or a benzene ring substituted with

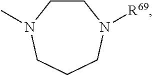

wherein R⁶⁹ is H, C₁₋₆ alkyl, —SO₂-(C₁₋₆ alkyl) or a 5- or 6-membered heterocycle having 1 to 4 heteroatoms N, S or O,

X³ and X⁴ are, independently of one another, —C(═O)—NH—, C(═O)—N(C₁ to C₆ alkyl), —NH—C(═O)—, —N(C₁ to C₆ alkyl)-C(═O)—, —CH₂—NH—, —CH₂—N(C₁ to C₆ alkyl)-, —NH—CH₂— or —N—(C₁-C₆ alkyl)-CH₂—,

R⁶⁵ is halogen, C₁ to C₆ alkyl or C₁ to C₆ alkoxy,

R⁶⁶ and R⁶⁷ are, independently of one another, H, halogen, CN, NH—SO₂-(C₁₋₆ alkyl), —NH—CO-(C₁₋₆ alkyl), —CO-(C₁₋₆ alkyl), —CO-(C₁₋₆ alkoxy), —C(O)NH₂, C₁₋₆ alkyl, C₁₋₆ alkoxy or S-(C₁₋₆ alkyl), and

R⁶⁸ is H, SO₃H or a sugar residue.

For example, the above-described factor Xa inhibitor can preferably be darexaban (N -(3-hydroxy-2-{[4-(4-methyl-1,4-diazepan-1-yl)-benzoyl]amino}phenyl)-4-methoxybenzamide), as for example described in EP 1 336 605.

In an alternative preferred configuration, it can be provided that the factor Xa inhibitor is selected from
vi) a compound of the following formula:

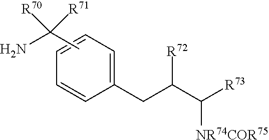

wherein R⁷⁰ and R⁷¹ are, independently of one another, H or ═NR⁸², wherein R⁸² is one of the groups R^{82a}O₂C—, R^{82a}O—, HO—, amino, CN, R^{82a}CO—, HCO—, C₁₋₆ alkyl, NO₂, aralkyl or heteroaralkyl, wherein R^{82a} is alkyl, or aralkyl including heteroalkyl,

R⁷² is CO₂H, CO₂(C₁₋₆ alkyl), CHO, —CH₂OH, —CH₂SH, —C(O)(C₁₋₆ alkyl), —CONH₂, —CON(C₁₋₆ alkyl)₂, —CH₂O(C₁₋₆ alkyl), —CH₂O-aryl, —CH₂S(C₁₋₆ alkyl) or CH₂S-aryl,

R⁷³ is H, alkyl, cycloalkyl, or CH₂ aryl,

R⁷⁴ is H or C₁₋₆ alkyl, and

R⁷⁵ is alkyl, alkenyl or aryl.

For example, the above-described factor Xa inhibitor can preferably be otamixaban (methyl(2R,3R)-2-{3-[amino(imino)methyl]benzyl}-3-{[4-(1-oxidopyridin-4-yl)benzoyl]amino}butoxide), as for example described in WO 97/24118.

In an alternative preferred configuration, it can be provided that the factor Xa inhibitor is selected from
vii) a compound of the following formula:

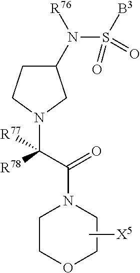

wherein X⁵ is one or more of (i) CF₃, F, COOH, C₁₋₆ alkyl, —CONH₂, CONH(C₁₋₃ alkyl), CON(C₁₋₃ alkyl)₂, C(O)-phenyl, a 5- to 6-membered cycloalkyl radical, a 5- to 6-membered heterocycle having at least one heteroatom O, N or S, or (ii) a second phenyl ring, a 5- to 6-membered cycloalkyl radical or a 5- to 6-membered aromatic heterocycle having at least one heteroatom O, N or S, wherein the second ring is fused to the heterocyclic ring of the above formula,

B³ is one of the following groups:

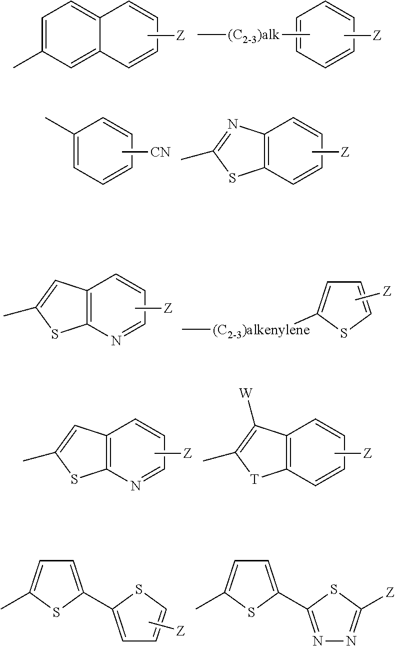

wherein alk is C₂₋₃ alkylene or C₂₋₃ alkenylene, T is S, O or N, W is C₁₋₃ alkyl, and

Z is H, OH or halogen,

R⁷⁶ is H, C₁₋₆ alkyl, C₃₋₆ alkenyl, phenyl or a 5- to 6-membered aromatic heterocyclic group, and

R⁷⁷ and R⁷⁸ are, independently of one another, H, C₁₋₃ alkyl or CF₃.

Examples for factor Xa inhibitors of the above-described compound are disclosed for example in WO 02/100830.

In an alternative preferred configuration, it can be provided that the factor Xa inhibitor is selected from
viii) a compound of the following formula:

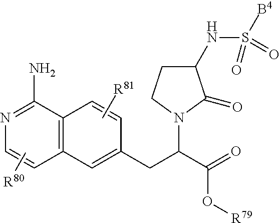

wherein B⁴ is one of the following groups:

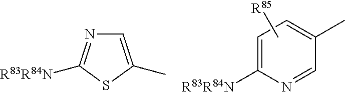

wherein R⁸³ and R⁸⁴ are, independently of one another, a C₁₋₆ alkyl or C₃₋₇ cycloalkyl group or, together with the N atom to which they are bonded, define a 3- to 7-membered heterocycloalkyl group having 1 or 2 heteroatoms N, O or S,

R⁸⁵ is H, halogen, CN, C₁₋₆ alkyl or C₁₋₆ alkoxy,

R⁷⁹ is H, a C₁₋₆ alkyl group or a C₃₋₇ cycloalkyl group,

R⁸⁰ is H or a C₁₋₆ alkyl group, and

R⁸¹ is OH, halogen, CN, a C₁₋₆ alkyl group or a C₁₋₆ alkoxy group.

Examples for factor Xa inhibitors of the above-described compound are disclosed for example in WO 2013/092756.

In an alternative preferred configuration, it can be provided that the factor Xa inhibitor is selected from
ix) a compound of the following formula:

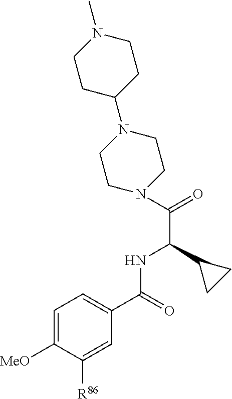

wherein R⁸⁶ is hydrogen or fluorine.

Examples for factor Xa inhibitors of the above-described compound are disclosed for example in WO 03/084929.

### Factor IIa Inhibitors

It can preferably be provided that the composition has at least one factor IIa inhibitor as clotting factor inhibitor, wherein the at least one factor IIa inhibitor is preferably a thrombin inhibitor. It can be particularly preferably provided that the thrombin inhibitor is selected from the group consisting of the following listed thrombin inhibitors i)-vi).

It was possible to demonstrate that these factor IIa inhibitors are particularly well suited to the composition because they can be particularly advantageously influenced by the Pgp inhibitor and are well suited for oral consumption.

In a preferred configuration, it can be provided that the thrombin inhibitor is selected from
i) a compound of the following formula:

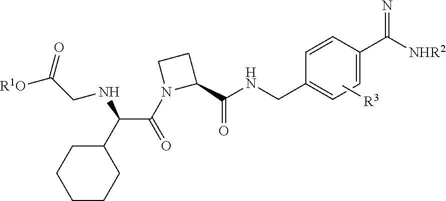

wherein R¹ is H, C₁₋₄ alkyl, C₁₋₄ alkylphenyl, A¹C(O)N(R⁴)R⁵ or A¹C(O)OR⁴, wherein A¹ is a C₁₋₅ alkylene, R⁴ and R⁵ are, independently of one another, H, C₁₋₆ alkyl, phenyl, 2-naphthyl or, if R¹ is A¹C(O)N(R⁴)R⁵, they are, together with the nitrogen atom to which they are bonded, pyrrolidinyl or piperidinyl,

R² is OH, OC(O)R⁶ or C(O)OR⁷, wherein R⁶ is a C₁₋₁₇ alkyl, phenyl or 2-naphthyl, R⁷ is a C₁₋₃ alkylphenyl, phenyl, 2-naphthyl, or C₁₋₁₂ alkyl, and

R³ is H or C₁₋₄ alkyl.

Examples for thrombin inhibitors of the above-described compound are disclosed in WO 1994/029336 and/or WO 1997/23499. For example, melagatran is a thrombin inhibitor according to one configuration of the present invention, which binds reversibly and with high affinity to the active center of thrombin. A prodrug form, ximelagatran (Exanta, Exarta, Exantan®) is for example also a thrombin inhibitor according to a preferred configuration.

In an alternative preferred configuration, it can be provided that the thrombin inhibitor is selected from
ii) a compound of the following formula:

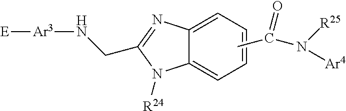

wherein R²⁴ is C₁₋₆ alkyl or C₃₋₇ cycloalkyl,

Ar³ is a phenylene, naphthylene, thienylene, thiazolylene, pyridinylene, pyrimidinylene, pyrazinylene or pyridazinylene group,

Ar⁴ is a phenyl group or a 2-pyridinyl group,

R²⁵ is (a) a C₁₋₃ alkyl group, or (b) a C₂₋₃ alkyl group substituted with a hydroxyl-, benzyloxy-, carboxy-C₁₋₃ alkylamino-, C₁₋₃ alkoxycarbonyl-C₁₋₃ alkylamino-, N—(C₁₋₃ alkyl)-carboxy-C₁₋₃ alkylamino- or N—(C₁₋₃ alkyl)-C₁₋₃ alkoxycarbonyl-C₁₋₃ alkylamino group,

E is a cyano or R²⁶NH—C(═NH) group, in which R²⁶ is a hydrogen atom, a hydroxyl group, a C₁₋₃ alkyl group or a residue that is cleavable in vivo.

Examples for thrombin inhibitors of the above-described compound are disclosed for example in WO 1998/37075. For example, dabigatran is a thrombin inhibitor according to one configuration of the present invention, which is a competitive, reversible and direct thrombin inhibitor. A prodrug, dabigatranetexilat (Pradaxa®), which is converted in vivo into dabigatran, is described in more detail in international patent application WO 03/074056, and is also a thrombin inhibitor according to one configuration of the present invention.

In an alternative preferred configuration, it can be provided that the thrombin inhibitor is selected from
iii) a compound of the following formula:

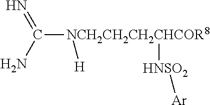

wherein Ar is phenyl, quinolinyl, tetrahydroquinolinyl, naphthyl, naphthoquinone or indane,

R⁸ is

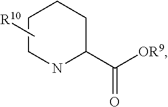

wherein R⁹ is H, a C₁₋₁₀ alkyl, a C₆₋₁₀ aryl, a C₇₋₁₂ aralkyl or 5-indanyl, and R¹⁰ is a C₁₋₅ alkyl or alkoxy.

For example, a thrombin inhibitor of the above-described formula, argatroban (Argatra®), can be a thrombin inhibitor according to one configuration. Argatroban is an arginine derivative which, however, has to be applied parenterally. However, it can be administered in a micelle-based formulation, which is also consumed orally. Such a formulation is described in US patent application U.S. Pat. No. 5,679,690. A lipid emulsion of such a compound is also disclosed in European patent application EP 0 608 828. A solid salt of argatroban, which is obtained by precipitation and lyophilization and which should be suitable for oral consumption, is disclosed in US patent application US 2009/0221637.

In an alternative preferred configuration, it can be provided that the thrombin inhibitor is selected from
iv) a compound of the following formula:

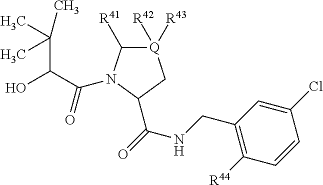

wherein Q is C or Si,

R⁴¹ is H or, together with R⁴², defines a C₃₋₈ carbocycle,

R⁴² is halogen, CF₃, or C₁₋₆ alkyl or, together with R⁴³, defines a C₃₋₈ carbocycle or, together with R⁴¹, defines a C₃₋₈ carbocycle,

R⁴³ is H, halogen, OH, C₁₋₆ alkyl or, together with R⁴², defines a C₃₋₈ carbocycle,

R⁴⁴ is a heterocycle, —(CR⁴⁵R⁴⁶)₂NH₂ or —(CR⁴⁵R⁴⁶)NH₂, wherein R⁴⁵ and R⁴⁶ are, independently of one another, H, C₁₋₆ alkyl, —CH₂F, —CHF₂, CF₃ or —CH₂OH.

Examples for thrombin inhibitors of the above-described compound are disclosed for example in WO 2014/058538.

In an alternative preferred configuration, it can be provided that the thrombin inhibitor is selected from
v) a compound of the following formula:

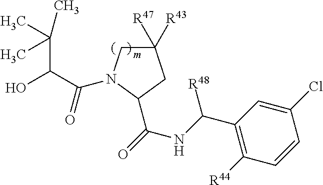

wherein m is 0 or 1,

R⁴³ is H, halogen, OH, C₁₋₆ alkyl or, together with R⁴⁷, defines a C₃₋₈ carbocycle,

R⁴⁴ is a heterocycle, —(CR⁴⁵R⁴⁶)₂NH₂ or —(CR⁴⁵R⁴⁶)NH₂, wherein R⁴⁵ and R⁴⁶ are, independently of one another, H, C₁₋₆ alkyl, —CH₂F, —CHF₂, CF₃ or —CH₂OH,

R⁴⁷ is H, halogen, CF₃, C₁₋₆ alkyl or, together with R⁴³, defines a C₃₋₈ carbocycle, and

R⁴⁸ is C₁₋₆ alkyl.

Examples for thrombin inhibitors of the above-described compound are disclosed for example in WO 2014/028318.

In an alternative preferred configuration, it can be provided that the thrombin inhibitor is selected from
vi) a compound of the following formula:

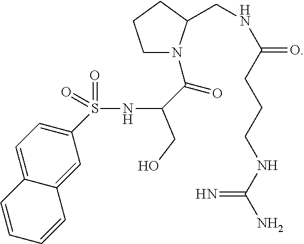 [SMILES: N=C(N)NCCCC(=O)NCC1CCCN1C(=O)C(CO)NS(=O)(=O)c1ccc2ccccc2c1]

The above-described thrombin inhibitor is also known under the name BMS 186282, and for example described by Malley, M. F., Tabernero, L., Chang, C. Y., Ohringer, S. L., Roberts, D. G., Das, J., Sack, J. S .: Crystallographic determination of the structures of human alpha-thrombin complexed with BMS-186282 and BMS-189090.

Alternatively, it can preferably be provided that the composition has at least one factor IIa inhibitor as clotting factor inhibitor, wherein the at least one factor IIa inhibitor is preferably a thrombin receptor antagonist. It can be particularly preferably provided that the thrombin receptor antagonist is selected from the group consisting of the following listed thrombin receptor antagonist i)-iv)

It was possible to demonstrate that these factor IIa inhibitors and preferred thrombin receptor antagonist are particularly well suited to the composition because they can be particularly advantageously influenced by the Pgp inhibitor and are well suited for oral consumption.

In a preferred configuration, it can be provided that the thrombin receptor antagonist is selected from
i) a compound of the following formula:

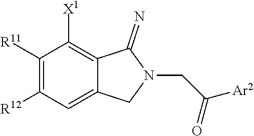

wherein Ar² is a phenyl or morpholino group,

X¹ is H or halogen, and

R¹¹ and R¹² are, independently of one another, H, methoxy or ethoxy.

Examples for thrombin receptor antagonists of the above-described formula are also described in EP 1 813 282. For example, a thrombin receptor antagonist can be the above-described compound atopaxar, also known as E5555. Atopaxar is a hydrobromide having the IUPAC name 1-(3-tert-butyl-4-methoxy-5-morpholin-4-ylphenyl)-2-(5,6-diethoxy-4-fluoro-3-imino-1H-isoindol-2-yl)ethanone-hydrobromide.

In an alternative preferred configuration, it can be provided that the thrombin receptor antagonist is selected from
ii) a compound of the following formula:

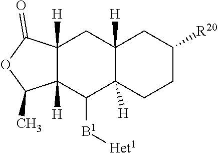

wherein Het¹ is a mono- or bicyclic heteroaromatic group of 5 to 10 atoms, containing 1 to 9 carbon atoms and 1 to 4 of the heteroatoms N, O or S, and

B¹ is (CH₂)ₙ₁, cis- or trans-(CH₂)ₙ₂CR¹⁴═CR¹⁵(CH₂)ₙ₃ or (CH₂)ₙ₂C≡C(CH₂)ₙ₃, wherein n₁ is 0 to 5 and n₂ and n₃ are, independently of one another, 0 to 2, R¹⁴ and R¹⁵ are, independently of one another, H, C₁₋₆ alkyl or halogen, and R²⁰ is H, C₁₋₆ alkyl, C₃₋₈ cycloalkyl, —NHC(O)OR²¹, or —NHC(O)R²¹, wherein R²¹ is H, C₁₋₆ alkyl, C₁₋₆ alkyl-OH, or C₁₋₆alkoxy.

Examples for thrombin receptor antagonists of the above-described formula are also described in US 2003/216437. For example, a thrombin receptor antagonist can be the above-described compound vorapaxar (Zontivity®), also known as SCH 530348. This is N -[(3R,3aS,4S,4aR,7R, 8aR,9aR)-4-[(E)-2-[5-(3-fluorophenyl)-2-pyridyl]vinyl]-3-methyl-1-oxo-3a,4,4a,5,6,7,8,8a,9,9a-decahydro-3H-benzo[f]isobenzofuran-7-yl]carbamate.

In an alternative preferred configuration, it can be provided that the thrombin receptor antagonist is selected from
iii) a compound of the following formula:

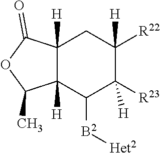

wherein Het² is a mono- or bicyclic heteroaromatic group of 5 to 14 atoms, containing 1 to 13 carbon atoms and 1 to 4 heteroatoms N, O or S,

B² is (CH₂)ₙ₁, —CH₂—O—, —CH₂—S—, —CH₂—NR¹³—, —C(O)NR¹³—, —NR¹³C(O)—,

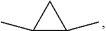

cis- or trans-(CH₂)ₙ₂CR¹⁴═CR¹⁵(CH₂)ₙ₃ or (CH₂)ₙ₂C≡C(CH₂)ₙ₃, wherein n₁ is 0 to 5 and n₂ and n₃ are, independently of one another, 0 to 2, wherein R¹³ is H, C₁₋₆ alkyl, phenyl, C₃₋₇ cycloalkyl, (C₃₋₇ cycloalkyl)-(C₁₋₆ alkyl), (C₁₋₆ alkoxy)-(C₁₋₆ alkyl), (C₁₋₆ alkyl)-OH or -(C₁₋₆ alkyl)amino, and R¹⁴ and R¹⁵ are, independently of one another, H, C₁₋₆ alkyl or halogen,

R²² and R²³ are, independently of one another, H, R¹⁶(C₁₋₁₀ alkyl), R¹⁶(C₂₋₁₀ alkenyl), R¹⁶(C₂₋₁₀ alkynyl), R¹⁶(C₁₋₁₀ alkyl), heterocycloalkyl, R¹⁷-aryl, R¹⁷-aryl)-(C₁₋₈ alkyl), —OH, —OC(O)—R¹⁸, CO(O)R¹⁹, —C(O)—R¹⁸, —C(O)N—R¹⁸R¹⁹ or —N—R¹⁸R¹⁹, wherein R¹⁶ and R¹⁷ are, independently of one another, H, a halogen or —OH, and R¹⁸ and R¹⁹ are, independently of one another, H or C₁₋₁₀ alkyl.

Examples for thrombin receptor antagonists of the above-described compound are disclosed for example in WO 01/96330.

In an alternative preferred configuration, it can be provided that the thrombin receptor antagonist is selected from
iv) a compound of the following formula:

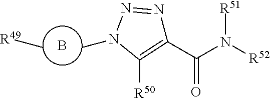

wherein B is a monocyclic aromatic ring,

R¹⁹ is —NHCOR⁵³, —NHSO₂R⁵⁴, —NHCON(R⁵⁵)(R⁵⁶), —NHCOOR⁵⁷ or —CONHR⁵⁸, wherein R⁵³ to R⁵⁸ are, independently of one another, H, a hydrocarbon group, a heterocyclic group or an alkoxy group, and

R⁵⁰ and R⁵² are, independently of one another, H, a hydrocarbon group, a heterocyclic group or an alkoxy group.

Examples for thrombin receptor antagonists of the above-described compound are disclosed for example in EP 1 867 331.

### Combination of Clotting Factor Inhibitors

It can preferably be provided that the composition has at least one factor Xa inhibitor and at least one factor IIa inhibitor as clotting factor inhibitors.

This makes it possible to achieve particularly potent clotting inhibition even at a comparatively low dose of both clotting factor inhibitors. This also makes it possible to achieve a particularly low risk of cross-contamination in predators or scavengers, since both clotting factor inhibitors are metabolized differently.

Without being bound to a theory, it is assumed that the combination of a factor Xa inhibitor and a factor IIa inhibitor is particularly efficient because two clotting factors are inhibited which are usually potentiated in functioning clotting inhibition, as a result of which efficient clotting inhibition can be achieved even at low doses.

Thus, the combination of these clotting factor inhibitors makes it possible to achieve an effect that goes beyond the effect of the individual clotting factor inhibitors.

### Additional Platelet Aggregation Inhibitor

It can preferably be provided that the composition additionally has:
c) at least one platelet aggregation inhibitor.

Additionally inhibiting platelet aggregation makes it possible not only for individual clotting factors, for example the clotting factors of the end sections of the intrinsic and the extrinsic blood clotting cascades, to be directly inhibited, but also the aggregation capacity of the clotting factors in the corresponding clotting factor complexes overall. This makes it possible in particular to achieve further potentiation of the clotting inhibition.

Thus, the additional platelet aggregation inhibitor makes it possible to achieve an effect that goes beyond the effect of the clotting factor inhibitors and the platelet aggregation inhibitors alone.

It can preferably be provided that the at least one platelet aggregation inhibitor is selected from the group consisting of cyclooxygenase inhibitors, P2Y12 receptor antagonists, phosphodiesterase inhibitors and glycoprotein GPIIb/IIIa receptor antagonists.

It can preferably be provided that the platelet aggregation inhibitor is a cyclooxygenase inhibitor selected from the group consisting of a compound of the following formula i).

It was possible to demonstrate that these platelet aggregation inhibitors are particularly well suited to the composition, since they particularly efficiently inhibit potentiation of clotting by the clotting factors.

In a preferred configuration, it can be provided that the cyclooxygenase inhibitor is selected from
i) a compound of the following formula:

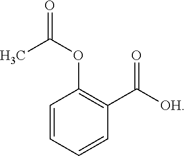

It can preferably be provided that the platelet aggregation inhibitor is a P2Y12 receptor antagonist selected from the group consisting of a compound of the following formulae i)-ix).

It was possible to demonstrate that these platelet aggregation inhibitors are particularly well suited to the composition, since they particularly efficiently inhibit potentiation of clotting by the clotting factors.

In a preferred configuration, it can be provided that the P2Y12 receptor antagonist is selected from i) a compound of the following formula:

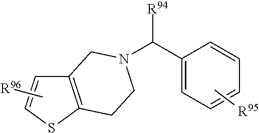

wherein R⁹⁴ is H, halogen, hydroxyl or C₁₋₆ alkyl,

R⁹⁵ is H, halogen, hydroxyl, nitro, C₁₋₆ alkyl or C₁₋₄ alkoxy, and

R⁹⁶ is H or halogen.

For example, an above-described compound can be ticlopidine (Tiklyd®), as described in U.S. Pat. Nos. 4,051,141 and 4,591,592. According to one configuration, the P2Y12 receptor antagonist can also be a prodrug which can be converted in vivo into an active metabolite of the above-described compound.

In an alternative preferred configuration, it can be provided that the P2Y12 receptor antagonist is selected from
ii) a compound of the following formula:

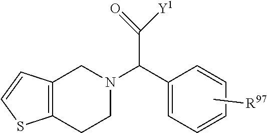

wherein Y¹ is —OR⁹⁸ or —N(R⁹⁹)R¹⁰⁰, wherein R⁹⁹ and R¹⁰⁰ are, independently of one another, H, halogen or a C₁₋₄ alkyl group, and R⁹⁸ is H or C₁₋₄ alkyl, and

R⁹⁷ is H, halogen, or a C₁₋₄ alkyl group.

For example, an above-described compound can be clopidogrel (Iscovera, Plavix®), an orally administrable platelet aggregation inhibitor according to EP 0 099 802 and U.S. Pat. No. 4,529,596. According to one configuration, the P2Y12 receptor antagonist can also be a prodrug which is only converted in vivo into an active metabolite and is described in U.S. Pat. No. 4,847,265.

In an alternative preferred configuration, it can be provided that the P2Y12 receptor antagonist is selected from
iii) a compound of the following formula:

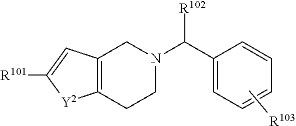

wherein R¹⁰¹ is H, OH, amino, C₁ to C₄ alkoxy, Ar—C₁₋₄ alkyloxy, C₁₋₁₈ alkanoyloxy,

C₃₋₆ alkenoyloxy or arylcarbonyloxy,

R¹⁰² is C₁₋₁₀ alkanoyl, C₃₋₆ l alkenoyl, C₄₋₈ cycloalkylcarbonyl having 3 to 7 ring atoms, substituted benzoyl and 5,6-dihydro-1,4,2-dioxazin-3-yl,

Y² is NH, O or S, and

R¹⁰³ is H, halogen, OH, amino, C₁₋₄ alkyl, C₁₋₄ alkoxy, C₁₋₄ alkylthio or a carboxy group.

For example, the P2Y12 receptor antagonist can be prasugrel ((RS)-[5-[2-cyclopropyl-1-(2-fluorophenyl)-2-oxoethyl]-6,7-dihydro-4H-thieno[3,2-c]pyridin-2-yl]acetate), as described in EP 0 099 802 or U.S. Pat. No. 5,288,726, a prodrug which is converted in vivo into an active metabolite containing thiol.

In an alternative preferred configuration, it can be provided that the P2Y12 receptor antagonist is selected from
iv) a compound of the following formula:

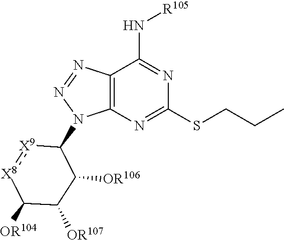

wherein R¹⁰⁴ is H, halogen, hydroxy-C₁₋₈ alkyl, C₁₋₈ alkoxy-C₁₋₈ alkyl or carboxy-C₁₋₈ alkyl,

R¹⁰⁵ is C₁₋₈ alkyl, C₁₋₈ alkoxy-C₁₋₈ alkylthio-C₁₋₈ alkyl, C₃₋₈ cycloalkyl-C₁₋₈ alkyl, phenyl-C₁₋₈ alkyl, heterocyclyl, heterocyclyl-C₁₋₈ alkyl, heteroaryl-C₁₋₈ alkyl or halo-C₁₋₈ alkyl,

R¹⁰⁶ and R¹⁰⁷ are, independently of one another, H, or, together with the carbon atom to which they are bonded, define a 5- or 6-membered heterocycle, and

X⁸ and X⁹ are, independently of one another, CH, CH₂ or CH(OH), and [symbol] is a single bond or a double bond.

Examples for P2Y12 receptor antagonists of the above-described compound are described in WO 2008/054796.

In an alternative preferred configuration, it can be provided that the P2Y12 receptor antagonist is selected from
v) a compound of the following formula:

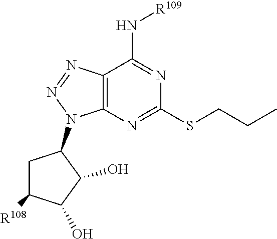

wherein R¹⁰⁸ is heterocyclyl, heterocyclyl-C₁₋₈ alkyl, heteroaryl, heteroaryl-C₁₋₈ alkyl or halo-C₁₋₈ alkyl, and

R¹⁰⁹ is C₁₋₈ alkyl, C₁₋₈ alkoxy-C₁₋₈ alkylthio-C₁₋₈ alkyl, C₃₋₈ cycloalkyl, C₃₋₈ cycloalkyl-C₁₋₈ alkyl, phenyl-C₁₋₈ alkyl, heterocyclyl-C₁₋₈ alkyl, heteroaryl-C₁₋₈ alkyl or halo-C₁₋₈.

Examples for P2Y12 receptor antagonists of the above-described compound are described in WO 2008/054795.

In an alternative preferred configuration, it can be provided that the P2Y12 receptor antagonist is selected from
vi) a compound of the following formula:

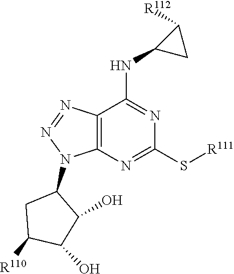

wherein R¹¹⁰ is OH, CH₂OH or OCH₂CH₂OH,

R¹¹¹ is C₃₋₅ alkyl,

R¹¹² is phenyl, including phenyl substituted with one or more F.

For example, an above-described compound can be ticagrelor (Brilinta®, Brilique®, Possia®), as described in WO 2000/34283.

In an alternative preferred configuration, it can be provided that the P2Y12 receptor antagonist is selected from
vii) a compound of the following formula:

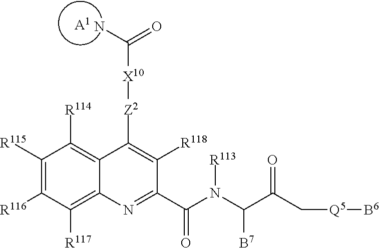

wherein R¹¹³ is H or C₁₋₄ alkyl,

R¹¹⁴ to R¹¹⁸ are, independently of one another, H, C₁₋₆ alkyl, C₁₋₃ fluoroalkyl, halogen, CN or phenyl,

X¹⁰ is C₃₋₈ alkylenyl, C₁₋₃ cycloalkylenyl or C₃₋₁₅ heterocyclyl,

Z² is alkylenyl, alkenyl or alkynyl,

A¹ is a 3- to 10-membered heterocyclic monocyclic, bicyclic or spiroheterocyclic ring containing 0, 1, 2 or 3 additional heteroatoms from N, S or O,

Q⁵ is a mono- or bicyclic 3- to 15-membered heterocycle, and

B⁶ and B⁷ are, independently of one another, H, C₁₋₄ alkyl, C₃₋₈ cycloalkyl, ₆₋₁₄ aryl, a 3- to 7-membered heterocycle, —C(O)OH, —CNH₂, —C(O)NH—(C₁₋₆ alkyl), —C(O)O—(C₁₋₆ alkyl) or —C(O)N(R)—R.

Examples for P2Y12 receptor antagonists of the above-described compound are described in WO 2008/128647.

In an alternative preferred configuration, it can be provided that the P2Y12 receptor antagonist is selected from
viii) a compound of the following formula:

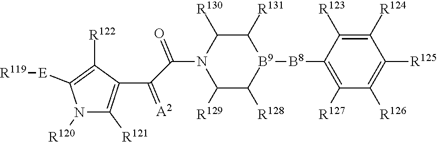

wherein A² is O or N—OH,

B⁸ is a covalent bond, —C(O)— or methylenyl,

B⁹ is N or CH,

E is a covalent bond, —O—C(O)— or —NH—C(O)—,

R¹¹⁹ is H, C₁₋₈ alkyl-, C₀₋₄ alkylene-(C₃₋₈ cycloalkyl), C₀₋₄ alkylene-(C₆₋₄ aryl) or C₀₋₄ alkylene-heterocyclyl,

R¹²⁰ is H, —NH—C(O)— or —O—C(O)—,

R¹²¹ is C₁₋₈ alkyl-, CF₃, or (C₁₋₈ alkylene)-C(O)—O—R¹³² and R¹²² is H, halogen, C₁ to C₈ alkyl-, (C₁₋₈ alkylene)-C(O)—O—R¹³², (C₂₋₆ alkenylene)-C(O)—O—R¹³² or C₃₋₇ cycloalkyl)-C(O)—O—R¹³², wherein R¹³² is H, C₁ to C₈ alkyl- or C₀₋₄ alkylene-(C₃₋₈-cycloalkyl),

R¹²³ to R¹²⁷ are, independently of one another, H, halogen, CN, NO₂, C₁₋₈ alkyl-, C₀₋₄ alkylene-O—R¹³², (C₀₋₄ alkylene)-C(O)—O—R¹³², (C₀₋₄ alkylene)-C(O)—R¹³², (C₀₋₄ alkylene)-C(O)—N—R¹³²R¹³³ or (C₀₋₄ alkylene)-CN—R¹³²R¹³³, wherein R¹³³ is H or C₁ to C₈ alkyl-, and

R¹²⁸ to R¹³¹ are, independently of one another, H, ═O, —OH or C₁ to C₈ alkyl-.

Examples for P2Y12 receptor antagonists of the above-described compound are described in WO 2008/155022.

In an alternative preferred configuration, it can be provided that the P2Y12 receptor antagonist is selected from
ix) a compound of the following formula:

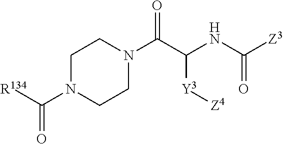

wherein Z³ is a substituted -2-thiazole ring or -4-thiazole ring, wherein a 2-thiazole ring is substituted at position 4 with H, an aryl group and/or at position 5 with H, halogen, C₁ to C₄ alkyl-, C₂ to C₄ alkenyl-, phenyl or di-C₁₋₆ alkylamino, and a 4-thiazole ring is substituted at position 2 with H or an aryl group and/or at position 5 with H, halogen, COOH, C₁ to C₄ alkyl-, COO(C₁₋₄ alkyl-), C₂₋₄ alkenyl-, phenyl, C₁₋₄ alkylamino, di-C₁₋₄ alkylamino, heterocyclyl or 2-methoxymethylcycloprop-1-yl,

Y³—Z⁴ either represent a bond and H, or Y³ is C₁ to C₃ alkanediyl and Z⁴ is H, OH, phenyl, —COOH, —COO(C₁₋₄ alkyl), —P(O)(OH)₂, —P(O)(O-[C₁₋₄ alkyl])₂, —P(O)(O-[C₁₋₄ alkoxy]-C(O)O—CH₂)₂ or —P(O)(NH[C₁₋₄ alkoxy]-C(O)—[C₁₋₄ alkyl])₂, and

R¹³⁴ is C₁ to C₆ alkoxy.

Examples for P2Y 12 receptor antagonists of the above-described compound are described in WO 2010/122504.

It can preferably be provided that the platelet aggregation inhibitor is a glycoprotein GPIIb/IIIa receptor antagonist selected from the group consisting of a compound of the following formulae i)-vi).

It was possible to demonstrate that these platelet aggregation inhibitors are particularly well suited to the composition, since they particularly efficiently inhibit potentiation of clotting by the clotting factors.

In a preferred configuration, it can be provided that the glycoprotein GPIIb/IIIa receptor antagonist is selected from
i) a compound of the following formula:

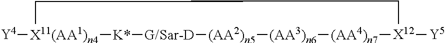

wherein Y⁴ and Y⁵ are, independently of one another, a non-interfering substituent or are absent,

K* is a substituted or unsubstituted lysyl residue of formula R¹³⁵R¹³⁶₂N(CH₂)₄CHNHCO, wherein R¹³⁵ and R¹³⁶ are, independently of one another, H or C₁ to C₆ alkyl,

X¹¹ and X¹² are, independently of one another, any desired residue which enables the ring formation shown between X¹¹ and X¹²,

(AA¹) is a small neutral amino acid and n₄ is a number from 0 to 3,

(AA²) is a large nonpolar amino acid and n₅ is a number from 0 to 3,

(AA³) is a proline residue or a modified proline residue and no is 0 or 1, and

(AA⁴) is a small neutral amino acid or an N-alkylated form thereof and n₇ is a number from 0 to 3.

For example, in one configuration, the glycoprotein GPIIb/IIIa receptor antagonist can be an arginyl-glycyl-aspartate mimetic, for example the peptide eptifibatide (Integrilin®)

In a preferred configuration, it can be provided that the glycoprotein GPIIb/IIIa receptor antagonist is selected from
ii) a compound of the following formula:

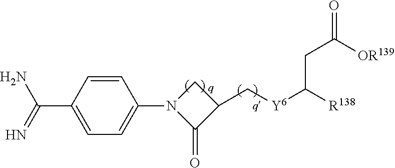

wherein Y⁶ is

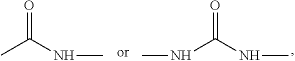

q is 2 or 3,

q′ is an integer from 0 to 4,

R¹³⁸ is H, C₁ to C₆ alkyl-, C₁ to C₈ alkoxy-, C₁ to C₈ alkoxycarbonyl-, C₂ to C₆ alkenyl, C₂ to C₆ alkyl, cycloalkyl or aryl,

R¹³⁹ is C₁ to C₆ alkyl-, C₂ to C₆ alkenyl, C₂ to C₆ alkynyl, alkoxycarbonyloxyalkyl and C₃ to C₆ cycloalkyl or aryl.

In one configuration, the glycoprotein GPIIb/IIIa receptor antagonist can for example be orbofiban (ethyl N-{[(3S)-1-(4-carbamimidoylphenyl)-2-oxo-3-pyrrolidinyl]carbamoyl}-β-alaninate), as for example described in U.S. Pat. No. 5,721,366.

In a preferred configuration, it can be provided that the glycoprotein GPIIb/IIIa receptor antagonist is selected from
iii) a compound of the following formula:

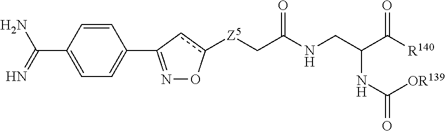

wherein Z⁵ is a covalent single bond, C₁ to C₇ alkyl-, C₂ to C₇ alkenyl or C₂ to C₇ alkynyl,

R¹³⁹ is C₁ to C₆ alkyl-, C₂ to C₆ alkenyl, C₂ to C₆ alkynyl, alkoxycarbonyloxyalkyl, C₃ to C₆ cycloalkyl or aryl,

R¹⁴⁰ is hydroxyl, C₁ to C₁₀ alkoxy-, C3 to C₁₀ alkylcarbonyloxyalkyloxy- or C₇ to C₁₁ aralkyloxy-, and

[symbol] is a single bond or a double bond.

In one configuration, the glycoprotein GPIIb/IIIa receptor antagonist can for example be roxifiban (DMP 754, MK 0853, XJ 754, Lumaxis®, methyl-N³-[2-{3-(4-formamidinophenyl) -isoxazolin-5-(R)-yl}-acetyl]-N²-(n-butyloxycarbonyl)-2,3-(S)-diaminopropionate), as described in WO 95/14683.

In a preferred configuration, it can be provided that the glycoprotein GPIIb/IIIa receptor antagonist is selected from
iv) a compound of the following formula:

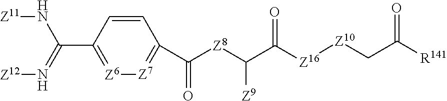

wherein one of Z⁶ and Z⁷ is CH and the other is CH, C₁ to C₈ alkyl-, C₁ to C₈ alkoxy or N,

Z⁸ is NH, C₁ to C₈ alkyl-N or C₁ to C₈ alkoxy-(C₁ to C₈ alkyl-)N,

Z⁹ is H or C₁ to C₈ alkyl optionally substituted with OH, SH, CONH₂, CONH—C₁ to C₈ alkyl, C₁ to C₈ alkylthio, aryl, NH₂, NH—(C₁ to C₈ alkyl-), N(C₁ to C₈ alkyl-)(C₁ to C₈ alkyl-) or O—(C₁ to C₈ alkyl-),

Z¹⁰ is O, CH₂, NH, acyl-N or C₁ to C₈ alkyl-OC(O)N.

Z¹¹ and Z¹² are H, C₁ to C₈ alkyl, OH, C₁ to C₈ alkoxy, C₁ to C₈ alkoxy- C₁ to C₈ alkyl, carboxy- C₁ to C₈ alkyl, P(O)(O—C₁ to C₈ alkyl)₂, C(O)O—C₁ to C₈ alkyl, OC(O)-C₁ to C₈ alkyl, OC(O)O—C₁ to C₈ alkyl or C(O)S—C₁ to C₈ alkyl, wherein at least one of Z¹¹ and Z¹² is H, or Z¹¹ and Z¹², together with the N atoms to which they are bonded, are a (5,5-dimethyl- or 5-oxo) -4,5-dihydro-1,2,4-oxadiazol-3-yl group,

Z¹⁶ is a 1,4-piperidinylene bonded to the keto group via the N atom, or is 1,4-phenylene optionally substituted with C₁ to C₈ alkyl, C₁ to C₈ alkoxy, OCH₂COOH or OCH₂COO—(C₁ to C₈alkyl), and

R¹⁴¹ is NH₂, NH(—C₁ to C₈ alkyl), NH—(C₁ to C₈ alkyl-)COOH, NH—(C₁ to C₈ alkyl)-COO—(C₁ to C₈ alkyl), C₁ to C₈ alkyloxy or C₁ to C₈ alkenyloxy.

In one configuration, the glycoprotein GPIIb/IIIa receptor antagonist can for example be sibrafiban (Ro 48-3657, Xubix®), as described in EP 0 656 348.

In a preferred configuration, it can be provided that the glycoprotein GPIIb/IIIa receptor antagonist is selected from
v) a compound of the following formula:

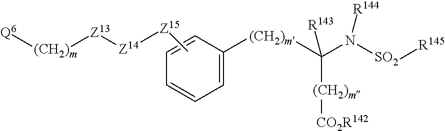

wherein Q⁶ is a four- to eight-membered heterocyclic ring having 1, 2, 3 or 4 heteroatoms which are N, O or S,

m is an integer from 0 to 8,

m′ and m″ are, independently of one another, an integer from 0 to 2,

Z¹³ and Z¹⁴ are, independently of one another, phenyl, O, SO₂,

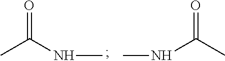

or a 5- or 6-membered ring containing 0 or 1 heteroatoms from N or O,

Z¹⁵ is an optionally present group which is O, —NHCO—, —CONH— or C₁ to C₅ alkyl-OC(O)N,

R¹⁴² is H or C₁ to C₈ alkyl,

R¹⁴³ and R¹⁴⁴ are, independently of one another, H, C₁ to C₄ alkyl or C₄ to C₁₀ aralkyl, and

R¹⁴⁵ is aryl, C₁ to C₁₀ alkyl or cycloalkyl or C₄ to C₁₀ aralkyl.

Examples for glycoprotein GPIIb/IIIa receptor antagonists of the above-described compound are described for example in WO 93/19046.

In a preferred configuration, it can be provided that the glycoprotein GPIIb/IIIa receptor antagonist is selected from
vi) a compound of the following formula:

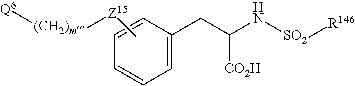

wherein Q⁶ is a six-membered heterocyclic ring having 1 or 2 heteroatoms which are N, m′″ is an integer from 2 to 6,

Z¹⁵ is

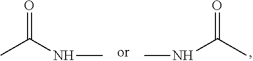

and

R¹⁴⁶ is aryl, C₁ to C₁₀ alkyl or Ca to C₁₀ aralkyl.

In one configuration, the glycoprotein GPIIb/IIIa receptor antagonist can for example be tirofiban ((S)-2-(butylsulfonamino)-3-(4-[4-(piperidin-4-yl)butoxy]phenyl)-propanoic acid, Aggrastat®), as described in WO 93/19046.

In a preferred configuration, it can be provided that the glycoprotein GPIIb/IIIa receptor antagonist is selected from the group of “fibans”, consisting of fradafiban, lamifiban, lefrafiban, lotrafiban, orbofiban, roxifiban, sibrafiban and xemilofiban.

It can preferably be provided that the composition has at least two platelet aggregation inhibitors, wherein preferably at least one platelet aggregation inhibitor is a cyclooxygenase inhibitor and at least one platelet aggregation inhibitor is a P2Y12 receptor antagonist or a glycoprotein GPIIb/IIIa receptor antagonist.

This advantageously makes it possible to achieve particularly efficient inhibition of platelet aggregation. This thus makes it possible to keep the dose particularly low, thereby reducing environmental impact and further reducing the risk of cross-contamination.

### Pgp Inhibitors

Preferably, the Pgp inhibitor can be selected from the drug groups consisting of: the group of the class C antiarrhythmics, for example amiodarone and dronedarone; calcium antagonists, for example diltiazem and verapamil; HMG-CoA reductase inhibitors or statins, for example atorvastatin, rosuvastatin, lovastatin and simvastatin; macrolide antibiotics, for example clarithromycin, roxithromycin and erythromycin; gyrase inhibitors, for example moxifloxacin, ofloxacin; azolamide antimycotics, for example fluconazole, voriconazole and itraconazole; antimalarials, for example mefloquine and quinidine; HIV drugs, for example ritonavir, nefinavir, saquinavir and elacridar; cytotstatic agents, for example tamoxifen and cyclosporin; immunosuppressants and cell cycle inhibitors, for example tacrolimus and ciclosporin; proton pump inhibitors, for example lansoprazole and omeprazole; and antiemetics, for example ondansetron.

It can preferably be provided that the at least one Pgp inhibitor inhibitor is selected from the group consisting of a compound of the following formulae i)-ix).

In a not preferred configuration, certain Pgp inhibitors have proven to be less effective in the context of the invention. In particular, ketoconazole (Nizoral®) belongs to these less effective compounds. It was found that although ketoconazole does have basic efficacy in the context of the invention, this efficacy is considerably lower compared to other Pgp inhibiting substances.

In one configuration, it can be provided that the Pgp inhibitor is selected from
i) a compound of the following formula:

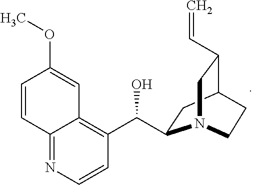 [SMILES: C=CC1C[N@@]2CCC1C[C@@H]2[C@@H](O)c1ccnc2ccc(OC)cc12]

The above-described Pgp inhibitor is also known under the name quinidine (Duriles®).

In an alternative preferred configuration, it can be provided that the Pgp inhibitor is selected from
ii) a compound of the following formula:

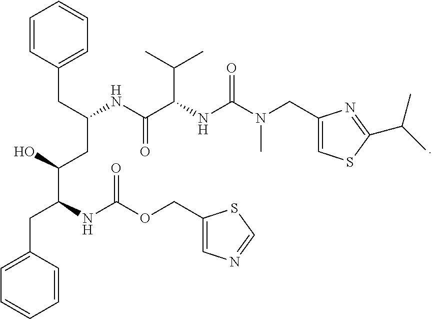 [SMILES: CC(C)c1nc(CN(C)C(=O)N[C@H](C(=O)N[C@@H](Cc2ccccc2)C[C@H](O)[C@H](Cc2ccccc2)NC(=O)OCc2cncs2)C(C)C)cs1]

The above-described Pgp inhibitor is also known under the name ritonavir (Norvir®).

In an alternative preferred configuration, it can be provided that the Pgp inhibitor is selected from
iii) a compound of the following formulae:

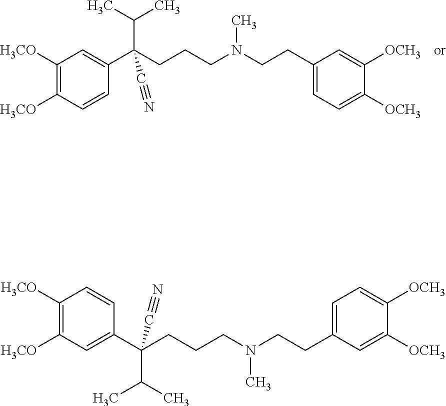 [SMILES: COc1ccc(CCN(C)CCC[C@@](C#N)(c2ccc(OC)c(OC)c2)C(C)C)cc1OC ; COc1ccc(CCN(C)CCC[C@](C#N)(c2ccc(OC)c(OC)c2)C(C)C)cc1OC]

or a mixture thereof, in particular a racemate thereof.

The above-described Pgp inhibitor is also known under the name verapamil (Isoptin®).

In an alternative preferred configuration, it can be provided that the Pgp inhibitor is selected from
iv) a compound of the following formula:

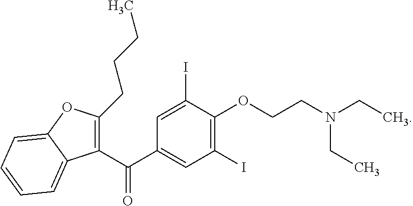 [SMILES: CCCCc1oc2ccccc2c1C(=O)c1cc(I)c(OCCN(CC)CC)c(I)c1]

The above-described Pgp inhibitor is also known under the name aminodarone (Cordarone®)

In an alternative preferred configuration, it can be provided that the Pgp inhibitor is selected from
v) a compound of the following formula:

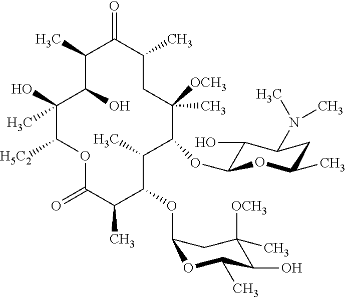

The above-described Pgp inhibitor is also known under the name clarithromycin (Klacid®).

In an alternative preferred configuration, it can be provided that the Pgp inhibitor is selected from
vi) a compound of the following formula:

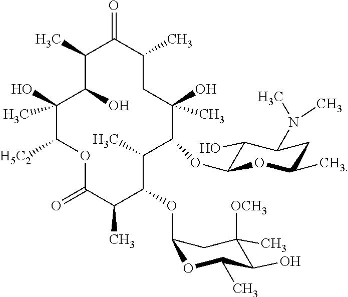

The above-described Pgp inhibitor is also known under the name erythromycin (Erythrocin®).

In an alternative preferred configuration, it can be provided that the Pgp inhibitor is selected from
vii) a compound of the following formulae:

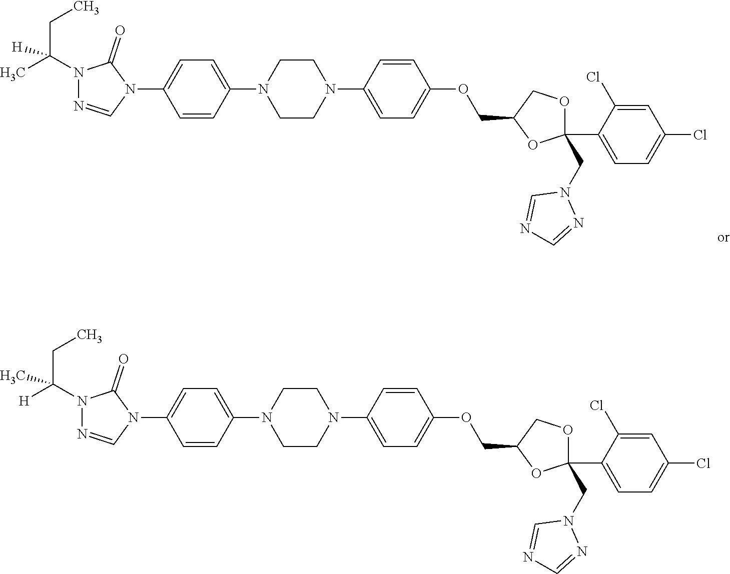 [SMILES: CC[C@H](C)n1ncn(-c2ccc(N3CCN(c4ccc(OC[C@H]5CO[C@](Cn6cncn6)(c6ccc(Cl)cc6Cl)O5)cc4)CC3)cc2)c1=O ; CC[C@@H](C)n1ncn(-c2ccc(N3CCN(c4ccc(OC[C@H]5CO[C@](Cn6cncn6)(c6ccc(Cl)cc6Cl)O5)cc4)CC3)cc2)c1=O]

or a mixture thereof, in particular a racemate thereof.

The above-described Pgp inhibitor is also known under the name itraconazole (Sporanox®).

In an alternative preferred configuration, it can be provided that the Pgp inhibitor is selected from
viii) a compound of the following formula:

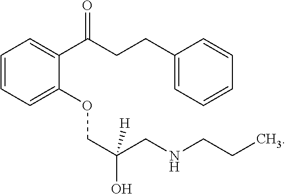

The above-described Pgp inhibitor is also known under the name propafenone (Rytmonorm®).

In a particularly preferred alternative configuration, it can be provided that the Pgp inhibitor is selected from
ix) a compound of the following formula:

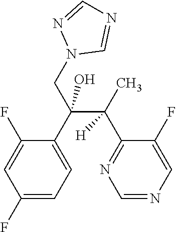 [SMILES: C[C@@H](c1ncncc1F)[C@](O)(Cn1cncn1)c1ccc(F)cc1F]

The above-described Pgp inhibitor is also known under the name voriconazole (VFend®). Surprisingly, in the context of the invention, this compound has proven to be a highly effective Pgp inhibitor and therefore forms a particularly preferred configuration of the invention.

In a further preferred alternative configuration, it can be provided that the Pgp inhibitor is selected from
x) a compound of the following formula:

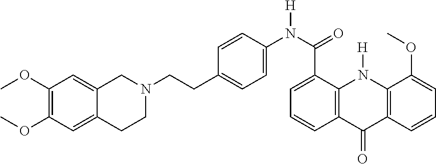 [SMILES: COc1cc2c(cc1OC)CN(CCc1ccc(NC(=O)c3cccc4c(=O)c5cccc(OC)c5[nH]c34)cc1)CC2]

The above-described Pgp inhibitor is also known under the name Elacridar.

In a further preferred alternative configuration, it can be provided that the Pgp inhibitor is selected from
xi) a compound of the following formula:

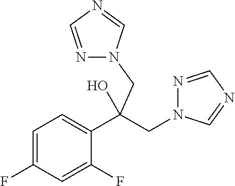 [SMILES: OC(Cn1cncn1)(Cn1cncn1)c1ccc(F)cc1F]

The above-described Pgp inhibitor is also known under the name fluconazole (Canifug-Fluco®, Diflucan®, Flunazul®, Fungata®).

### Further Subjects

The invention further proposes the use of an above-described composition as rodenticide. This should be understood to mean that the composition is used for controlling pest rodents.

For example, the composition can be provided in a pest rodent bait which is laid such that it is consumed as food by the pest rodents to be controlled.

The invention further also proposes a pest rodent bait containing the above-described composition.

For example, it can be provided that the pest rodent bait has a carrier and the above-described composition. The carrier can in particular be a composition that is attractive to pest rodents, or a suitable food for the pest rodent.

In some embodiments, a composition disclosed herein can be combined with a composition that contains a cereal flour, a cereal bran, a gelling agent, a sugar, an oil, an emulsifier and a humectant, as for example described in international patent application WO 2014/186885.

It can preferably be provided that the pest rodent bait has the composition in an amount that induces no acute toxicity when the a normal amount of food for the pest rodent is consumed. This makes it possible on the one hand for the toxicity of the pest rodent bait to not be immediately acutely toxic if accidentally ingested by other animals or for example by humans. This further makes it possible for the effect of the pest rodent bait to only arise upon repeated consumption, so that the pest rodents do not form any avoidance behavior in respect of the pest rodent bait.

The pest rodent bait can for example contain seeds and/or cereals. The pest rodent bait can for example be provided in the form of granules (or pellets), in the form of packaged cereals or packaged pellets, or as bait blocks. In some embodiments, a composition disclosed herein can be contained in a bait block which contains a polymeric binder in the form of a polymer based on an acrylic acid ester and acrylonitrile, as for example described in international patent application WO 2014/064272.

The invention further proposes a method for controlling pest rodents, wherein an above-described pest rodent bait is laid.

For example, it can be provided that the pest rodent bait is used in conjunction with a bait station, as is for example commercially available. This for example makes it possible to prevent the pest rodent bait from being eaten by larger animals.

The different active components can be offered to the animals in various baits as pellets. paste, edible bait, etc., the basis of which can in principle be composed of the following components: 20-70 wt % carbohydrates, 5-50 wt % fat, 10-40 wt % protein, the remainder being water, table salt and sugar.

It can preferably be provided that the individual components of the above-described composition are each present at a concentration in a range from greater than 0 ppm to less than or equal to 10 000 ppm relative to the total weight of the pest rodent bait, preferably greater than 10 ppm to less than or equal to 6000 ppm, in particular greater than 50 ppm to less than or equal to 5000 ppm relative to the total weight of the pest rodent bait.

According to a preferred configuration of the invention, it may be provided that the pest rodent bait contains a Pgp inhibitor at a concentration in a range from greater than 0 ppm to less than 6000 ppm relative to the total weight of the pest rodent bait, preferably greater than 250 ppm to less than or equal to 5500 ppm, in particular greater than 750 ppm to less than or equal to 5000.

According to a further preferred configuration of the invention, it may be provided that the pest rodent bait contains a factor Xa antagonist at a concentration in a range from greater than 0 ppm to less than or equal to 8000 ppm, preferably greater than 50 ppm to less than or equal to 5000 ppm, in particular greater than 100 ppm to less than or equal to 4000 ppm.

According to a further preferred configuration of the invention, it may be provided that the pest rodent bait contains a factor IIa antagonist at a concentration in a range from greater than 0 ppm to less than or equal to 8000 ppm, preferably greater than 50 ppm to less than or equal to 5000 ppm, in particular greater than 100 ppm to less than or equal to 4000 ppm.

According to a further preferred configuration of the invention, the pest rodent bait has between greater than or equal to 40 wt % and less than or equal to 75 wt % maize, between greater than or equal to 10 wt % and less than or equal to 45 wt % oat flakes, between greater than or equal to 3 wt % and less than or equal to 10 wt % peanut butter, between greater than or equal to 0.5 wt % and less than or equal to 5 wt % sugar, and also between greater than or equal to 0.4 wt % and less than or equal to 1.2 wt % salt, the remainder being water.

According to a further configuration of the invention, the pest rodent bait can contain between greater than or equal to 100 ppm and less than or equal to 2500 ppm, preferably between greater than or equal to 250 ppm and less than or equal to 1500 ppm, in particular between greater than or equal to 500 ppm and less than or equal to 1400 ppm of acetylsalicylic acid.

According to a further configuration of the invention, the pest rodent bait has between greater than or equal to 50 ppm and less than or equal to 1000 ppm, preferably between greater than or equal to 100 ppm and less than or equal to 800 ppm, in particular between greater than or equal to 200 ppm and less than or equal to 700 ppm of prasugrel.

The following table shows example pest rodent bait compositions according to the invention and the efficacy achieved with these compositions. The basic bait composition (standard chow) used consisted of 65% maize, 25% oat flakes, % peanut butter, 3% refined finely granulated sugar, and 1% fine table salt.

| | | | | Starting | End | | | | Time to | |
|---|---|---|---|---|---|---|---|---|---|---|
| | Factor Xa | Factor IIa | Pgp | weight | weight | | Mortality | | mortality | |
| | antagonist | antagonist | antagonist | (g) | (g) | | (%) | | (d) | |
| 1 | Apixaban I | -.- | Voriconazole I | 319 (247-383) | 284 | (221-343) | 50% | (5/10) | 9.4 | (7-12) |
| 2 | Apixaban II | -.- | Voriconazole I | 286 (223-337) | 248 | (202-278) | 70% | (7/10) | 8.6 | (6-11) |
| 3 | Apixaban III | -.- | Voriconazole II | 310 (252-371) | 243 | (212-301) | 70% | (7/10) | 8.3 | (5-11) |
| 4 | Apixaban II | | Voriconazole II | 291 (264-388) | 266 | (224-308) | 60% | (6/10) | 7.2 | (5-9) |
| 5 | Apixaban III | | Fluconazole | 321 (285-262) | 265 | (251, 278) | 80% | (8/10) | 6.9 | (5-10) |
| 6 | Apixaban III | | Ritonavir/elacridar | 304 (238-361) | 306 | | 90% | (9/10) | 6.4 | (5-8) |
| 7 | Rivaroxaban I | | Voriconazole I | 300 (246-325) | 277 | (247-306) | 60% | (6/10) | 8.2 | (7-10) |
| 8 | Rivaroxaban II | | Voriconazole I | 309 (253-358) | 299 | (286-312) | 70% | (7/10) | 7.1 | (6-8) |
| 9 | | Dabigatran II | Voriconazole I | 303 (273-358) | 289 | (282-300) | 70% | (7/10) | 8.2 | (7-10) |
| 10 | | Dabigatran III | Voriconazole I | 318 (273-358) | 271 | (241-304) | 60% | (6/10) | 8.8 | (7-11) |
| 11 | Apixaban II | Dabigatran I | Voriconazole II | 324 (267-351) | 302 | (267-336) | 80% | (8/10) | 6.8 | (7-12) |
| 12 | Apixaban II | Dabigatran II | Voriconazole II | 303 (236-366) | 317 | (279-356) | 70% | (7/10) | 6.6 | (5-8) |
| 13 | Apixaban II | Dabigatran III | Voriconazole I | 295 (241-338) | -.- | | 100% | (10/10) | 5.8 | (5-7) |
| 14 | Betrixaban | | Ketoconazole | 220 (215-341) | 184 | (140-288) | 30% | (3/10) | 10.3 | (5-13) |

The active clotting inhibitors were used at the following listed concentrations.

Anticoagulant:

| Betrixaban | Apixaban I | Apixaban II | Apixaban III | Rivaroxaban I | Rivaroxaban II | Dabigatran I | Dabigatran II | Dabigatran III |
|---|---|---|---|---|---|---|---|---|
| 6000 mg | 150 mg | 300 mg | 600 mg | 600 mg | 1200 mg | 1000 mg | 2000 mg | 4000 mg |

The Pgp inhibitors were used at the following listed concentration.

Pgp inhibitor

| Ketoconazole | Voriconazole I | Voriconazole II | Fluconazole | Ritonavir | Elacridar |
|---|---|---|---|---|---|
| 1300 mg | 1200 mg | 2400 mg | 1200 mg | 4000 mg | 4000 mg |

Surprisingly, it was found that in particular the use of voriconazole as Pgp inhibitor leads to high mortality even at comparatively low concentrations in combination with different active clotting inhibitors. In contrast, the addition of ketoconazole, even at high concentrations of active clotting inhibitor, exhibited significantly lower mortality.

1. A composition for controlling pest rodents, characterized in that the composition has:
a) at least one direct clotting factor inhibitor, and
b) at least one P-glycoprotein inhibitor (Pgp inhibitor), characterized in that the P-glycoprotein inhibitor (Pgp inhibitor) is at least one compound selected from the group consisting of amiodarone, dronedarone, diltiazem, verapamil, atorvastatin, rosuvastatin, lovastatin, simvastatin, clarithromycin, roxithromycin, erythromycin, moxifloxacin, ofloxacin, fluconazole, voriconazole, itraconazole, mefloquine, quinidine, ritonavir, nefinavir, saquinavir, elacridar, tamoxifen, cyclosporin, tacrolimus, ciclosporin, lansoprazole, omeprazole and ondansetron.

2. The composition for controlling pest rodents as claimed in claim 1, characterized in that the Pgp inhibitor in the composition is at least one compound selected from the group consisting of voriconazole, ritonavir, elacridar and fluconazole.

3. The composition as claimed in claim 1, characterized in that the clotting factor inhibitor is selected from the group consisting of factor Xa inhibitors and factor IIa inhibitors.

4. The composition as claimed in claim 1, characterized in that the composition has at least one factor Xa inhibitor as clotting factor inhibitor, wherein the at least one factor Xa inhibitor is preferably selected from the group consisting of:
i) a compound of the following formula: 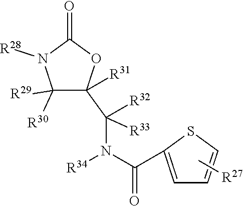
wherein R²⁷ is halogen, cyano, nitro, amino, aminomethyl, C₁₋₈ alkyl, C₃₋₇ cycloalkyl, C₁₋₈ alkoxy, imidazolinyl, —C(═NH)NH₂, carbamoyl or mono- and di-(C₁₋₄)-alkylaminocarbonyl, and
R²⁸, R²⁹, R³⁰, R³¹, R³², R³³ and R³⁴ are, independently of one another, H or C₁₋₆ alkyl;
ii) a compound of the following formula: 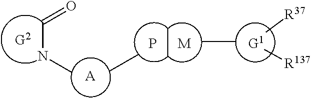
wherein A is a C₃-C₁₀ carbocycle or a 5-12-membered heterocycle composed of carbon atoms and 1-4 heteroatoms N, O or S,
P is a 5-7-membered carbocycle or a 5-7-membered heterocycle composed of carbon atoms and 1-3 heteroatoms N, O or S, and contains 0-3 double bonds in the ring,
M is a 3-10-membered carbocycle or a 4-10-membered heterocycle composed of carbon atoms and 1-3 heteroatoms N, O or S,
G¹ is phenyl, pyridyl, pyrimidyl, pyrazinyl or pyridazonyl,
G² is a 4-8-membered monocyclic or bicyclic hydrocarbon ring having 0 to 2 C═C double bonds, and
R³⁷ and R¹³⁷ are, independently of one another, H, —OH, F, Cl, Br, I, CN, C₁-C₄ alkyl, OCH₃, OCH₂CH₃, OCH₂CH₂CH₃, O(CH₃)₂, OCF₃ or amino;
iii) a compound of the following formula: 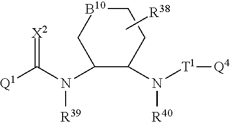
wherein Q¹ is a saturated or unsaturated 5- or 6-membered hydrocarbon ring, a saturated or unsaturated 5-7-membered heterocyclic group, a saturated or unsaturated bicyclic or tricyclic fused hydrocarbon group or a saturated or unsaturated bicyclic or tricyclic fused heterocyclic group,
B¹⁰ is N or CH₂,
X² is O or S,
R³⁸ is H, OH, alkoxy, alkyl, alkenyl, alkynyl, halogen, CN, amino, aminoalkyl, acyl, acylamino, carbamoyl, aryl or aralkyl,
R³⁹ and R⁴⁰ are, independently of one another, H, OH, an alkyl group or an alkoxy group,
Q⁴ is an aryl group, an arylalkenyl group, an arylalkynyl group, a heteroaryl group, a heteroarylalkenyl group, a saturated or unsaturated bicyclic or tricyclic fused hydrocarbon group or a saturated or unsaturated bicyclic or tricyclic fused heterocyclic group, and
T¹ is a carbonyl group, a sulfonyl group, —C(═O)—C(═O)-, —C(═O)—C(═O)—NH—,
—C(═O)—C(═O)—N(alkyl)-, —C(═O)—(C₁₋₅alkylene)-N(alkyl), —C(═O)—(C₁₋₅ alkylene)—NH—, —C(═O)—(C₁₋₅ alkylene)-C(═O)— or —C(═O)—N═N—;
iv) a compound of the following formula: 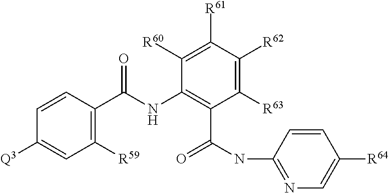
wherein Q³ is: 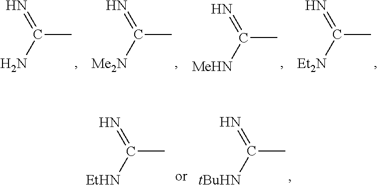
R⁵⁹ is H, F, Cl or Br,
R⁶⁰, R⁶¹, R⁶² and R⁶³ are, independently of one another, H, F, Cl, Br, Me, NO₂, OH, OMe, NH₂, NHAc, NHSO₂Me, CH₂OH or CH₂NH₂, and
R⁶⁴ is F, Cl, Br, Me, OH or OMe;
v) a compound of the following formula: 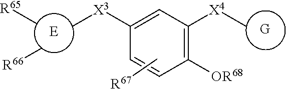
wherein E is a benzene ring or a 5- or 6-membered heterocycle having 1 to 4 heteroatoms N, S or O,
G is a piperidine ring or a benzene ring substituted with 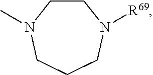
wherein R⁶⁹ is H, C₁₋₆ alkyl, —SO₂—(C₁₋₆ alkyl) or a 5- or 6-membered heterocycle having 1 to 4 heteroatoms N, S or O,
X³ and X⁴ are, independently of one another, —C(═O)—NH—, C(═O)—N(C₁ to C₆ alkyl), —NH—C(═O)—, —N(C₁ to C₆ alkyl)-C(═O)—, —CH₂—NH—, —CH₂-N(C₁ to C₆ alkyl)-, —NH—CH₂— or —N—(C₁-C₆ alkyl)-CH₂—,
R⁶⁵ is halogen, C₁ to C₆ alkyl or C₁ to C₆ alkoxy,
R⁶⁶ and R⁶⁷ are, independently of one another, H, halogen, CN, NH—SO₂—(C₁₋₆ alkyl), —NH—CO—(C₁₋₆ alkyl), —CO—(C₁₋₆ alkyl), —CO—(C₁₋₆ alkoxy), —C(O)NH₂, C₁₋₆ alkyl, C₁₋₆ alkoxy or S—(C₁₋₆ alkyl), and
R⁶⁸ is H, SO₃H or a sugar residue;
vi) a compound of the following formula: 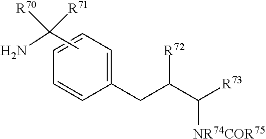
wherein R⁷⁰ and R⁷¹ are, independently of one another, H or ═NR⁸², wherein R⁸² is one of the groups R^{82a}O₂C—, R^{82a}O—, HO—, amino, CN, R^{82a}CO—, HCO—, C₁₋₆ alkyl, NO₂, aralkyl or heteroaralkyl, wherein R^{82a} is alkyl, or aralkyl including heteroalkyl,
R⁷² is CO₂H, CO₂(C₁₋₆ alkyl), CHO, —CH₂OH, —CH₂SH, —C(O)(C₁₋₆ alkyl), —CONH₂, —CON(C₁₋₆ alkyl)₂, —CH₂O(C₁₋₆ alkyl), —CH₂O-aryl, —CH₂S(C₁₋₆ alkyl) or CH₂S-aryl,
R⁷³ is H, alkyl, cycloalkyl, or CH₂ aryl,
R⁷⁴ is H or C₁₋₆ alkyl, and
R⁷⁵ is alkyl, alkenyl or aryl;
vii) a compound of the following formula: 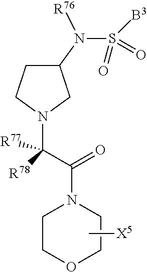
wherein X⁵ is one or more of (i) CF₃, F, COOH, C₁₋₆ alkyl, —CONH₂, CONH(C₁₋₃ alkyl), CON(C₁₋₃ alkyl)₂, C(O)-phenyl, a 5- to 6-membered cycloalkyl radical, a 5- to 6-membered heterocycle having at least one heteroatom O, N or S, or (ii) a second phenyl ring, a 5- to 6-membered cycloalkyl radical or a 5- to 6-membered aromatic heterocycle having at least one heteroatom O, N or S, wherein the second ring is fused to the heterocyclic ring of the above formula,
B³ is one of the following groups: 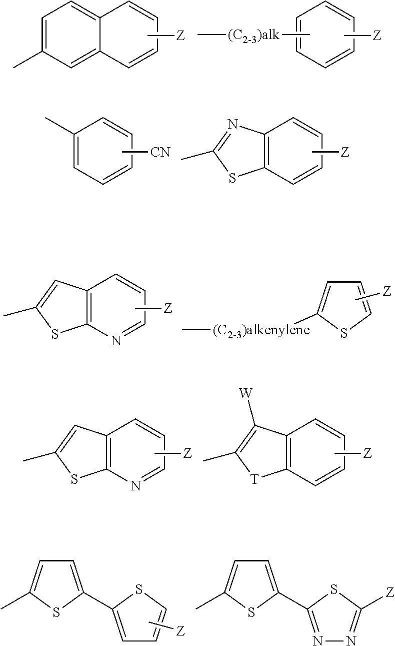
wherein alk is C₂₋₃ alkylene or C₂₋₃ alkenylene, T is S, O or N, W is C₁₋₃ alkyl, and
Z is H, OH or halogen,
R⁷⁶ is H, C₁₋₆ alkyl, C₃₋₆ alkenyl, phenyl or a 5- to 6-membered aromatic heterocyclic group, and
R⁷⁷ and R⁷⁸ are, independently of one another, H, C₁₋₃ alkyl or CF₃;
viii) a compound of the following formula: 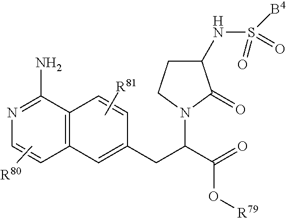
wherein B⁴ is one of the following groups: 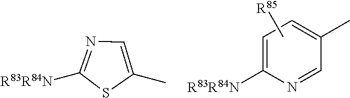
wherein R⁸³ and R⁸⁴ are, independently of one another, a C₁₋₆ alkyl or C₃₋₇ cycloalkyl group or, together with the N atom to which they are bonded, define a 3- to 7-membered heterocycloalkyl group having 1 or 2 heteroatoms N, O or S,
R⁸⁵ is H, halogen, CN, C₁₋₆ alkyl or C₁₋₆ alkoxy,
R⁷⁹ is H, a C₁₋₆ alkyl group or a C₃₋₇ cycloalkyl group,
R⁸⁰ is H or a C₁₋₆ alkyl group, and
R⁸¹ is OH, halogen, CN, a C₁₋₆ alkyl group or a C₁₋₆ alkoxy group, or
ix) a compound of the following formula: 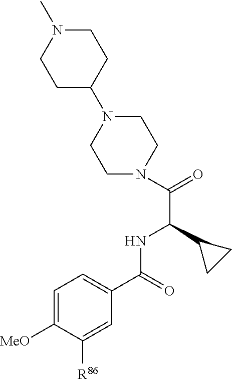
wherein R⁸⁶ is hydrogen or fluorine.

5. The composition as claimed in claim 1, characterized in that the composition has at least one factor IIa inhibitor as clotting factor inhibitor, wherein the at least one factor IIa inhibitor is preferably a thrombin inhibitor, particularly preferably selected from the group consisting of:
i) a compound of the following formula: 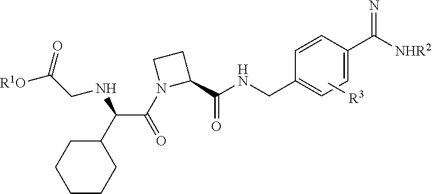
wherein R¹ is H, C₁₋₄ alkyl, C₁₋₄ alkylphenyl, A¹C(O)N(R⁴)R⁵ or A¹C(O)OR⁴, wherein A¹ is a C₁₋₅ alkylene, R⁴ and R⁵ are, independently of one another, H, C₁₋₆ alkyl, phenyl, 2-naphthyl or, if R¹ is A¹C(O)N(R⁴)R⁵, they are, together with the nitrogen atom to which they are bonded, pyrrolidinyl or piperidinyl,
R² is OH, OC(O)R⁶ or C(O)OR⁷, wherein R⁶ is a C₁₋₁₇ alkyl, phenyl or 2-naphthyl, R⁷ is a C₁₋₃ alkylphenyl, phenyl, 2-naphthyl, or C₁₋₁₂ alkyl, and
R³ is H or C₁₋₄ alkyl;
ii) a compound of the following formula: 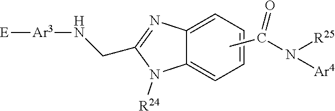
wherein R²⁴ is C₁₋₆ alkyl or C₃₋₇ cycloalkyl,
Ar³ is a phenylene, naphthylene, thienylene, thiazolylene, pyridinylene, pyrimidinylene, pyrazinylene or pyridazinylene group,
Ar⁴ is a phenyl group or a 2-pyridinyl group,
R²⁵ is (a) a C₁₋₃ alkyl group, or (b) a C₂₋₃ alkyl group substituted with a hydroxyl-, benzyloxy-, carboxy-C₁₋₃ alkylamino-, C₁₋₃ alkoxycarbonyl-C₁₋₃ alkylamino-, N—(C₁₋₃ alkyl) -carboxy-C₁₋₃ alkylamino- or N—(C₁₋₃ alkyl)-C₁₋₃ alkoxycarbonyl-C₁₋₃ alkylamino group,
E is a cyano or R²⁶NH—C(═NH) group, in which R²⁶ is a hydrogen atom, a hydroxyl group, a C₁₋₃ alkyl group or a residue that is cleavable in vivo;
iii) a compound of the following formula: 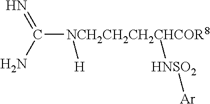
wherein Ar is phenyl, quinolinyl, tetrahydroquinolinyl, naphthyl, naphthoquinone or indane,
R⁸ is 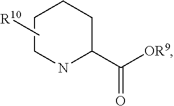
wherein R⁹ is H, a C₁₋₁₀ alkyl, a C₆₋₁₀ aryl, a C₇₋₁₂ aralkyl or 5-indanyl, and R¹⁰ is a C₁₋₅ alkyl or alkoxy;
iv) a compound of the following formula: 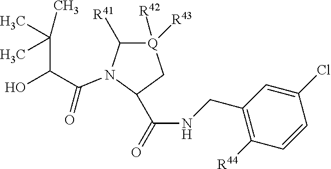
wherein Q is C or Si,
R⁴¹ is H or, together with R⁴², defines a C₃₋₈ carbocycle,
R⁴² is halogen, CF₃, or C₁₋₆ alkyl or, together with R⁴³, defines a C₃₋₈ carbocycle or, together with R⁴¹, defines a C₃₋₈ carbocycle,
R⁴³ is H, halogen, OH, C₁₋₆ alkyl or, together with R⁴², defines a C₃₋₈ carbocycle,
R⁴⁴ is a heterocycle, —(CR⁴⁵R⁴⁶)₂NH₂ or —(CR⁴⁵R⁴⁶)NH₂, wherein R⁴⁵ and R⁴⁶ are, independently of one another, H, C₁₋₆ alkyl, —CH₂F, —CHF₂, CF₃ or —CH₂OH;
v) a compound of the following formula: 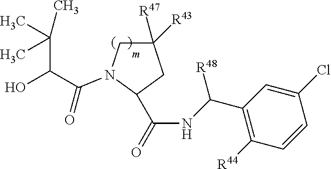
wherein m is 0 or 1,
R⁴³ is H, halogen, OH, C₁₋₆ alkyl or, together with R⁴⁷, defines a C₃₋₈ carbocycle,
R⁴⁴ is a heterocycle, —(CR⁴⁵R⁴⁶)₂NH₂ or —(CR⁴⁵R⁴⁶)NH₂, wherein R⁴⁵ and R⁴⁶ are, independently of one another, H, C₁₋₆ alkyl, —CH₂F, —CHF₂, CF₃ or —CH₂OH,
R⁴⁷ is H, halogen, CF₃, C₁₋₆ alkyl or, together with R⁴³, defines a C₃₋₈ carbocycle, and
R⁴⁸ is C₁₋₆ alkyl; or
vi) a compound of the following formula: 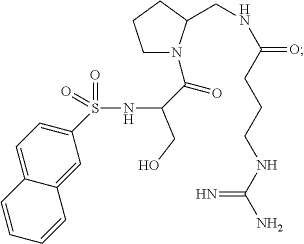 [SMILES: N=C(N)NCCCC(=O)NCC1CCCN1C(=O)C(CO)NS(=O)(=O)c1ccc2ccccc2c1]
or wherein the at least one factor IIa inhibitor is preferably a thrombin receptor antagonist, particularly preferably selected from the group consisting of:
i) a compound of the following formula: 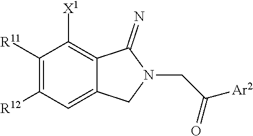
wherein Ar² is a phenyl or morpholino group,
X¹ is H or halogen, and
R¹¹ and R¹² are, independently of one another, H, methoxy or ethoxy;
ii) a compound of the following formula: 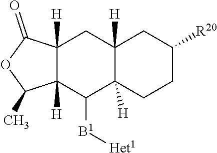
wherein Het¹ is a mono- or bicyclic heteroaromatic group of 5 to 10 atoms, containing 1 to 9 carbon atoms and 1 to 4 of the heteroatoms N, O or S, and
B¹ is (CH₂)ₙ₁, cis- or trans-(CH₂)n₂CR¹⁴═CR¹⁵(CH₂)ₙ₃ or (CH₂)ₙ₂C≡C(CH₂)ₙ₃, wherein n₁ is 0 to 5 and n₂ and n₃ are, independently of one another, 0 to 2, R¹⁴ and R¹⁵ are, independently of one another, H, C₁₋₆ alkyl or halogen, and R²⁰ is H, C₁₋₆ alkyl, C₃₋₈ cycloalkyl, —NHC(O)OR²¹, or —NHC(O)R²¹, wherein R²¹ is H, C₁₋₆ alkyl, C₁₋₆ alkyl-OH, or C₁₋₆alkoxy;
iii) a compound of the following formula: 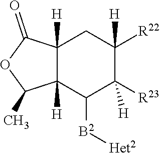
wherein Het² is a mono- or bicyclic heteroaromatic group of 5 to 14 atoms, containing 1 to 13 carbon atoms and 1 to 4 heteroatoms N, O or S,
B² is (CH₂)ₙ₁, —CH₂—O—, —CH₂—S—, —CH₂—NR¹³—, —C(O)NR¹³—, —NR¹³C(O)—, 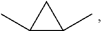
cis- or trans-(CH₂)ₙ₂CR¹⁴═CR¹⁵(CH₂)ₙ₃ or (CH₂)ₙ₂C≡C(CH₂)ₙ₃, wherein n₁ is 0 to 5 and n₂ and n₃ are, independently of one another, 0 to 2, wherein R¹³ is H, C₁₋₆ alkyl, phenyl, C₃₋₇ cycloalkyl, (C₃₋₇ cycloalkyl)-(C₁₋₆ alkyl), (C₁₋₆ alkoxy)-(C₁₋₆ alkyl), (C₁₋₆ alkyl)-OH or —(C₁₋₆ alkyl)amino, and R¹⁴ and R¹⁵ are, independently of one another, H, C₁₋₆ alkyl or halogen,
R²² and R²³ are, independently of one another, H, R¹⁶(C₁₋₁₀ alkyl), R¹⁶(C₂₋₁₀ alkenyl), R¹⁶(C₂₋₁₀ alkynyl), R¹⁶(C₁₋₁₀ alkyl), heterocycloalkyl, R¹⁷-aryl, R¹⁷-aryl)-(C₁-C₈ alkyl), —OH, —OC(O)—R¹⁸, CO(O)R¹⁹, —C(O)—R¹⁸, —C(O)N—R¹⁸R¹⁹ or —N—R¹⁸R¹⁹, wherein R¹⁶ and R¹⁷ are, independently of one another, H, a halogen or —OH, and R¹⁸ and R¹⁹ are, independently of one another, H or C₁₋₁₀ alkyl; or
iv) a compound of the following formula: 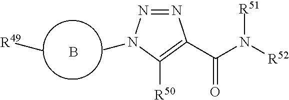
wherein B is a monocyclic aromatic ring,
R⁴⁹ is —NHCOR⁵³, —NHSO₂R⁵⁴, —NHCON(R⁵⁵)(R⁵⁶), —NHCOOR⁵⁷ or —CONHR⁵⁸, wherein R⁵³ to R⁵⁸ are, independently of one another, H, a hydrocarbon group, a heterocyclic group or an alkoxy group, and
R⁵⁰ and R⁵² are, independently of one another, H, a hydrocarbon group, a heterocyclic group or an alkoxy group.

6. The composition as claimed in claim 1, characterized in that the composition has at least one factor Xa inhibitor and at least one factor IIa inhibitor as clotting factor inhibitor.

7. The composition as claimed in claim 1, characterized in that the composition additionally has:
c) at least one platelet aggregation inhibitor.

8. The composition as claimed in claim 7, characterized in that the at least one platelet aggregation inhibitor is selected from the group consisting of cyclooxygenase inhibitors, P2Y12 receptor antagonists, phosphodiesterase inhibitors and glycoprotein GPIIb/IIIa receptor antagonists.

9. The composition as claimed in claim 7, characterized in that the at least one platelet aggregation inhibitor is a cyclooxygenase inhibitor selected from the group consisting of:
i) a compound of the following formula: 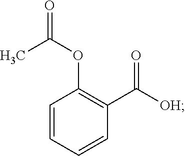
or the at least one platelet aggregation inhibitor is a P2Y12 receptor antagonist selected from the group consisting of:
i) a compound of the following formula: 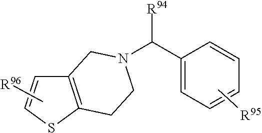
wherein R⁹⁴ is H, halogen, hydroxyl or C₁₋₆ alkyl,
R⁹⁵ is H, halogen, hydroxyl, nitro, C₁₋₆ alkyl or C₁₋₄ alkoxy, and
R⁹⁶ is H or halogen;
ii) a compound of the following formula: 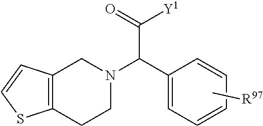
wherein Y¹ is —OR⁹⁸ or —N(R⁹⁹)R¹⁰⁰, wherein R⁹⁹ and R¹⁰⁰ are, independently of one another, H, halogen or a C₁₋₄ alkyl group, and R⁹⁸ is H or C₁₋₄ alkyl, and
R⁹⁷ is H, halogen, or a C₁₋₄ alkyl group;
iii) a compound of the following formula: 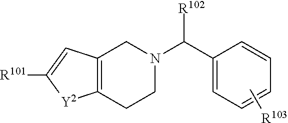
wherein R¹⁰¹ is H, OH, amino, C₁ to C₄ alkoxy, Ar—C₁₋₄ alkyloxy, C₁₋₁₈ alkanoyloxy, C₃₋₆ alkenoyloxy or arylcarbonyloxy,
R¹⁰² is C₁₋₁₀ alkanoyl, C₃₋₆ alkenoyl, C₄₋₈ cycloalkylcarbonyl having 3 to 7 ring atoms, substituted benzoyl and 5,6-dihydro-1,4,2-dioxazin-3-yl,
Y² is NH, O or S, and
R¹⁰³ is H, halogen, OH, amino, C₁₋₄ alkyl, C₁₋₄ alkoxy, C₁₋₄ alkylthio or a carboxy group;
iv) a compound of the following formula: 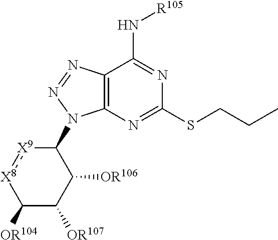
wherein R¹⁰⁴ is H, halogen, hydroxy-C₁₋₈ alkyl, C₁₋₈ alkoxy-C₁₋₈ alkyl or carboxy-C₁₋₈ alkyl,
R¹⁰⁵ is C₁₋₈ alkyl, C₁₋₈ alkoxy-C₁₋₈ alkylthio-C₁₋₈ alkyl, C₃₋₈ cycloalkyl-C₁₋₈ alkyl, phenyl-C₁₋₈ alkyl, heterocyclyl, heterocyclyl-C₁₋₈ alkyl, heteroaryl-C₁₋₈ alkyl or halo-C₁₋₈ alkyl,
R¹⁰⁶ and R¹⁰⁷ are, independently of one another, H, or, together with the carbon atom to which they are bonded, define a 5- or 6-membered heterocycle, and
X⁸ and X⁹ are, independently of one another, CH, CH₂ or CH(OH), and [symbol]
is a single bond or a double bond;
v) a compound of the following formula: 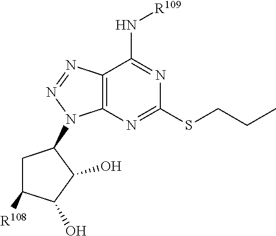
wherein R¹⁰⁸ is heterocyclyl, heterocyclyl-C₁₋₈ alkyl, heteroaryl, heteroaryl-C₁₋₈ alkyl or halo-C₁₋₈ alkyl, and
R¹⁰⁹ is C₁₋₈ alkyl, C₁₋₈ alkoxy-C₁₋₈ alkylthio-C₁₋₈ alkyl, C₃₋₈ cycloalkyl, C₃₋₈ cycloalkyl-C₁₋₈ alkyl, phenyl-C₁₋₈ alkyl, heterocyclyl-C₁₋₈ alkyl, heteroaryl-C₁₋₈ alkyl or halo-C₁₋₈ alkyl;
vi) a compound of the following formula: 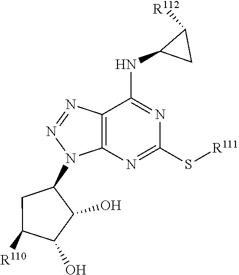
wherein R¹¹⁰ is OH, CH₂OH or OCH₂CH₂OH,
R¹¹¹ is C₃₋₅ alkyl,
R¹¹² is phenyl, including phenyl substituted with one or more F;
vii) a compound of the following formula: 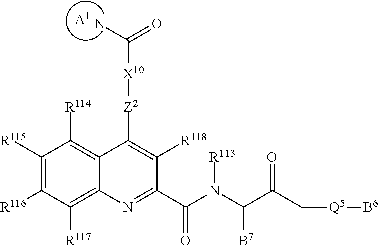
wherein R¹¹³ is H or C₁₋₄ alkyl,
R¹¹⁴ to R¹¹⁸ are, independently of one another, H, C₁₋₆ alkyl, C₁₋₃ fluoroalkyl, halogen, CN or phenyl,
X¹⁰ is C₃₋₈ alkylenyl, C₁₋₃ cycloalkylenyl or C₃₋₁₅ heterocyclyl,
Z² is alkylenyl, alkenyl or alkynyl,
A¹ is a 3- to 10-membered heterocyclic monocyclic, bicyclic or spiroheterocyclic ring containing 0, 1, 2 or 3 additional heteroatoms from N, S or O,
Q⁵ is a mono- or bicyclic 3- to 15-membered heterocycle, and
B⁶ and B⁷ are, independently of one another, H, C₁₋₄ alkyl, C₃₋₈ cycloalkyl, C₆₋₁₄ aryl, a 3- to 7-membered heterocycle, —C(O)OH, —CNH₂, —C(O)NH—(C₁₋₆ alkyl), —C(O)O—(C₁₋₆ alkyl) or —C(O)N(R)—R;
viii) a compound of the following formula: 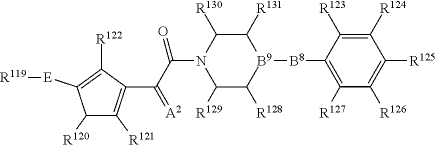
wherein A² is O or N—OH,
B⁸ is a covalent bond, —C(O)— or methylenyl,
B⁹ is N or CH,
E is a covalent bond, —O—C(O)— or —NH—C(O)—,
R¹¹⁹ is H, C₁₋₈ alkyl-, C₀₋₄ alkylene-(C₃₋₈ cycloalkyl), C₀₋₄ alkylene-(C₆₋₄ aryl) or C₀₋₄ alkylene-heterocyclyl,
R¹²⁰ is H, —NH—C(O)— or —O—C(O)—,
R¹²¹ is C₁₋₈ alkyl-, CF₃, or (C₁₋₈ alkylene)—C(O)—O—R¹³² and R¹²² is H, halogen, C₁ to C₈ alkyl-, (C₁₋₈ alkylene)—C(O)—O—R¹³², (C₂₋₆ alkenylene)-C(O)—O—R¹³² or C₃₋₇ cycloalkyl)-C(O)—O—R¹³², wherein R¹³² is H, C₁ to C₈ alkyl- or C₀₋₄ alkylene-(C₃₋₈-cycloalkyl),
R¹²³ to R¹²⁷ are, independently of one another, H, halogen, CN, NO₂, C₁₋₈ alkyl-, C₀₋₄ alkylene-O—R¹³², (C₀₋₄ alkylene)—C(O)—O—R¹³², (C₀₋₄ alkylene)-C(O)—R¹³², (C₀₋₄ alkylene)-C(O)—N—R¹³²R 133 or (C₀₋₄ alkylene)-CN—R¹³²R¹³³, wherein R¹³³ is H or C₁ to C₈ alkyl-, and
R¹²⁸ to R¹³¹ are, independently of one another, H, ═O, —OH or C₁ to C₈ alkyl -; or
ix) a compound of the following formula: 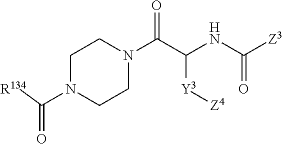
wherein Z³ is a substituted -2-thiazole ring or -4-thiazole ring, wherein a 2-thiazole ring is substituted at position 4 with H, an aryl group and/or at position 5 with H, halogen, C₁ to C₄ alkyl-, C₂ to C₄ alkenyl-, phenyl or di-C₁₋₆ alkylamino, and a 4-thiazole ring is substituted at position 2 with H or an aryl group and/or at position 5 with H, halogen, COOH, C₁ to C₄ alkyl-, COO(C₁₋₄ alkyl-), C₂₋₄ alkenyl-, phenyl, C₁₋₄ alkylamino, di-C₁₋₄ alkylamino, heterocyclyl or 2-methoxymethylcycloprop-1-yl,
Y³—Z⁴ either represent a bond and H, or Y³ is C₁ to C₃ alkanediyl and Z⁴ is H, OH, phenyl, —COOH, —COO(C₁₋₄ alkyl), —P(O)(OH)₂, —P(O)(O—[C₁₋₄ alkyl])₂, —P(O)(O—[C₁₋₄ alkoxy]—C(O)O—CH₂)₂ or —P(O)(NH[C₁₋₄ alkoxy]-C(O)—[C₁₋₄ alkyl])₂, and
R¹³⁴ is C₁ to C₆ alkoxy;
or the at least one platelet aggregation inhibitor is a glycoprotein GPIIb/IIIa receptor antagonist selected from the group consisting of:
i) a compound of the following formula: 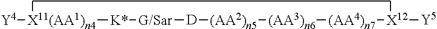
wherein Y⁴ and Y⁵ are, independently of one another, a non-interfering substituent or are absent,
K* is a substituted or unsubstituted lysyl residue of formula R¹³⁵R¹³⁶₂N(CH₂)₄CHNHCO, wherein R¹³⁵ and R¹³⁶ are, independently of one another, H or C₁ to C₆ alkyl,
X¹¹ and X¹² are, independently of one another, any desired residue which enables the ring formation shown between X¹¹ and X¹²,
(AA¹) is a small neutral amino acid and n₄ is a number from 0 to 3,
(AA²) is a large nonpolar amino acid and n₅ is a number from 0 to 3,
(AA³) is a proline residue or a modified proline residue and n₆ is 0 or 1, and
(AA⁴) is a small neutral amino acid or an N-alkylated form thereof and n₇ is a number from 0 to 3;
ii) a compound of the following formula: 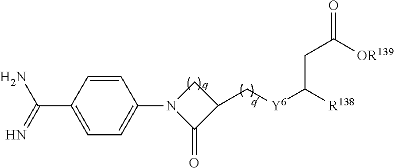
wherein Y⁶ is 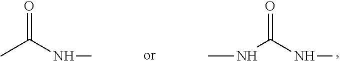
q is 2 or 3,
q′ is an integer from 0 to 4,
R¹³⁸ is H, C₁ to C₆ alkyl-, C₁ to C₈ alkoxy-, C₁ to C₈ alkoxycarbonyl-, C₂ to C₆ alkenyl, C₂ to C₆ alkyl, cycloalkyl or aryl,
R¹³⁹ is C₁ to C₆ alkyl-, C₂ to C₆ alkenyl, C₂ to C₆ alkynyl, alkoxycarbonyloxyalkyl and
C₃ to C₆ cycloalkyl or aryl;
iii) a compound of the following formula: 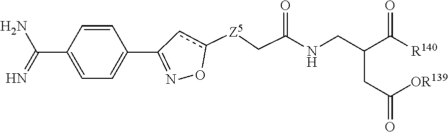
wherein Z⁵ is a covalent single bond, C₁ to C₇ alkyl-, C₂ to ₇ alkenyl or C₂ to C₇ alkynyl,
R¹³⁹ is C₁ to C₆ alkyl-, C₂ to C₆ alkenyl, C₂ to C₆ alkynyl, alkoxycarbonyloxyalkyl, C₃ to C₆ cycloalkyl or aryl,
R¹⁴⁰ is hydroxyl, C₁ to C₁₀ alkoxy-, C₃ to C₁₀ alkylcarbonyloxyalkyloxy- or C₇ to C₁₁ aralkyloxy-, and [symbol]
is a single bond or a double bond;
iv) a compound of the following formula: 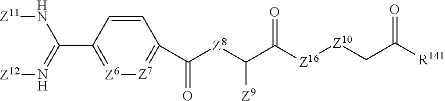
wherein one of Z⁶ and Z⁷ is CH and the other is CH, C₁ to C₈ alkyl-, C₁ to C₈ alkoxy or N,
Z⁸ is NH, C₁ to C₈ alkyl-N or C₁ to C₈ alkoxy-(C₁ to C₈ alkyl-)N,
Z⁹ is H or C₁ to C₈ alkyl optionally substituted with OH, SH, CONH₂, CONH— C₁ to C₈ alkyl, C₁ to C₈ alkylthio, aryl, NH₂, NH—(C₁ to C₈ alkyl-), N(C₁ to C₈ alkyl-)(C₁ to C₈ alkyl-) or O-(C₁ to C₈ alkyl-),
Z¹⁰ is O, CH₂, NH, acyl-N or C₁ to C₈ alkyl-OC(O)N,
Z¹¹ and Z¹² are H, C₁ to C₈ alkyl, OH, C₁ to C₈ alkoxy, C₁ to C₈ alkoxy- C₁ to C₈ alkyl, carboxy- C₁ to C₈ alkyl, P(O)(O—C₁ to C₈ alkyl)₂, C(O)O—C₁ to C₈ alkyl, OC(O)—C₁ to C₈ alkyl, OC(O)O—C₁ to C₈ alkyl or C(O)S—C₁ to C₈ alkyl, wherein at least one of Z¹¹ and Z¹² is H, or Z¹¹ and Z¹², together with the N atoms to which they are bonded, are a (5,5-dimethyl- or 5-oxo)-4,5-dihydro-1,2,4-oxadiazol-3-yl group,
Z¹⁶ is a 1,4-piperidinylene bonded to the keto group via the N atom, or is 1,4-phenylene optionally substituted with C₁ to C₈ alkyl, C₁ to C₈ alkoxy, OCH₂COOH or OCH₂COO—(C₁ to C₈alkyl), and
R¹⁴¹ is NH₂, NH(—C₁ to C₈ alkyl), NH—(C₁ to C₈ alkyl-)COOH, NH—(C₁ to C₈ alkyl)-COO—(C₁ to C₈ alkyl), C₁ to C₈ alkyloxy or C₁ to C₈ alkenyloxy;
v) a compound of the following formula: 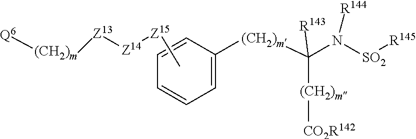
wherein Q⁶ is a four- to eight-membered heterocyclic ring having 1, 2, 3 or 4 heteroatoms which are N, O or S,
m is an integer from 0 to 8,
m′ and m″ are, independently of one another, an integer from 0 to 2,
Z¹³ and Z¹⁴ are, independently of one another, phenyl, O, SO₂, 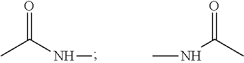
or a 5- or 6-membered ring containing 0 or 1 heteroatoms from N or O,
Z¹⁵ is an optionally present group which is O, —NHCO—, —CONH— or C₁ to C₅ alkyl-OC(O)N,
R¹⁴² is H or C₁ to C₈ alkyl,
R¹⁴³ and R¹⁴⁴ are, independently of one another, H, C₁ to C₄ alkyl or C₄ to C₆ aralkyl, and
R¹⁴⁵ is aryl, C₁ to C₁₀ alkyl or cycloalkyl or C₄ to C₁₀ aralkyl; or
vi) a compound of the following formula: 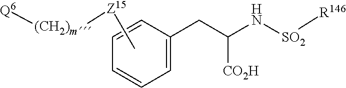
wherein Q⁶ is a six-membered heterocyclic ring having 1 or 2 heteroatoms which are N, m′″ is an integer from 2 to 6,
Z¹⁵ is 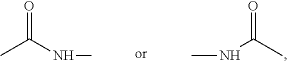
and
R¹⁴⁶ is aryl, C₁ to C₁₀ alkyl or C₄ to C₁₀ aralkyl.

10. The composition as claimed in claim 7, characterized in that the composition has at least two platelet aggregation inhibitors, wherein preferably at least one platelet aggregation inhibitor is a cyclooxygenase inhibitor and at least one platelet aggregation inhibitor is a P2Y12 receptor antagonist or a glycoprotein GPIIb/IIIa receptor antagonist.

11. The composition as claimed in claim 1, characterized in that the at least one Pgp inhibitor is selected from the group consisting of:
i) a compound of the following formula: 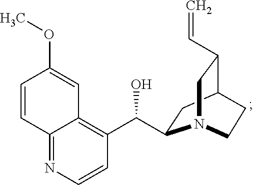 [SMILES: C=CC1C[N@@]2CCC1C[C@@H]2[C@@H](O)c1ccnc2ccc(OC)cc12]
ii) a compound of the following formula: 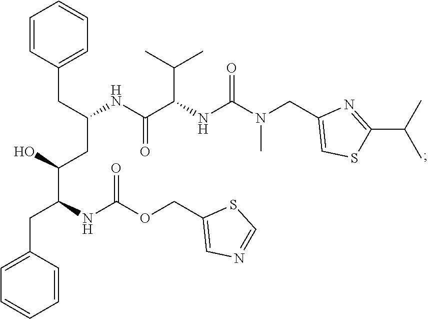 [SMILES: CC(C)c1nc(CN(C)C(=O)N[C@H](C(=O)N[C@@H](Cc2ccccc2)C[C@H](O)[C@H](Cc2ccccc2)NC(=O)OCc2cncs2)C(C)C)cs1]
iii) a compound of the following formulae: 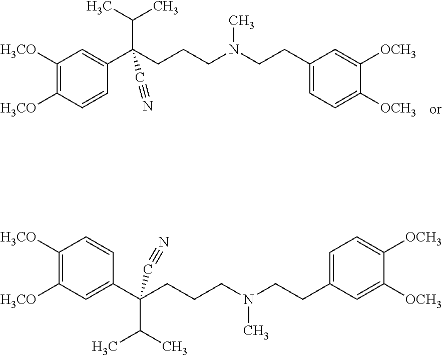 [SMILES: COc1ccc(CCN(C)CCC[C@@](C#N)(c2ccc(OC)c(OC)c2)C(C)C)cc1OC ; COc1ccc(CCN(C)CCC[C@](C#N)(c2ccc(OC)c(OC)c2)C(C)C)cc1OC]
or a mixture thereof, in particular a racemate thereof;
iv) a compound of the following formula: 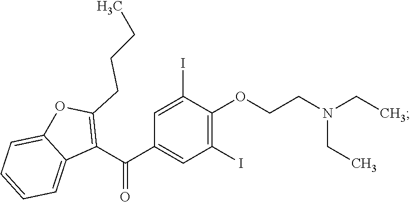 [SMILES: CCCCc1oc2ccccc2c1C(=O)c1cc(I)c(OCCN(CC)CC)c(I)c1]
v) a compound of the following formula: 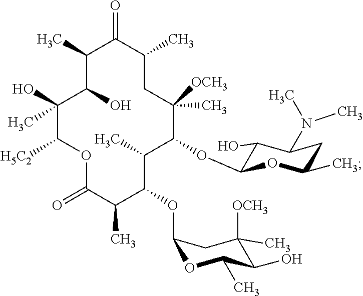
vi) a compound of the following formula: 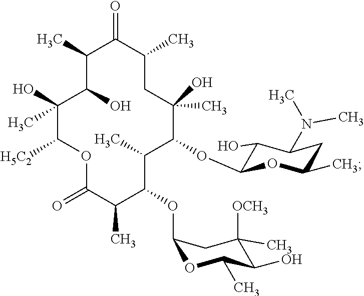
vii) a compound of the following formulae: 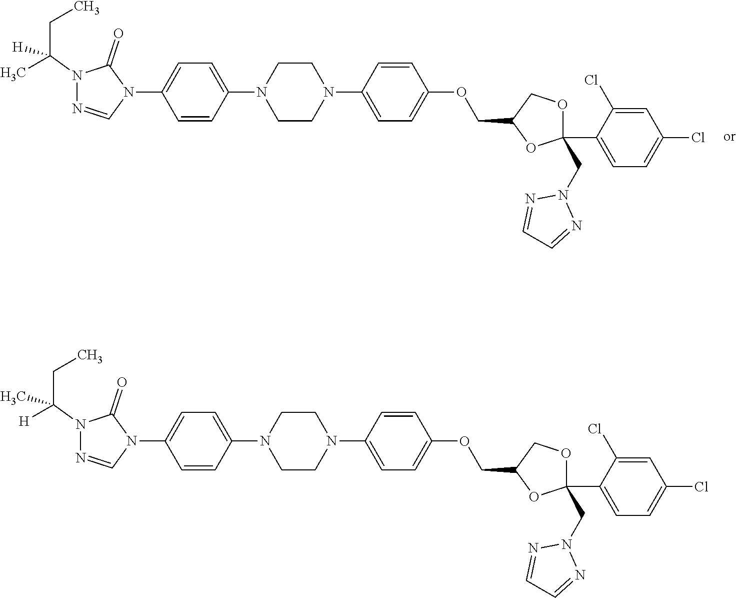
or a mixture thereof, in particular a racemate thereof; or
viii) a compound of the following formula: 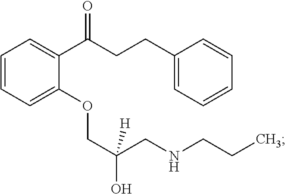 [SMILES: CCCNC[C@@H](O)COc1ccccc1C(=O)CCc1ccccc1]
or
ix) a compound of the following formulae: 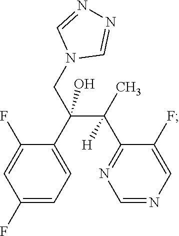 [SMILES: C[C@@H](c1ncncc1F)[C@](O)(Cn1cnnc1)c1ccc(F)cc1F]
or
x) a compound of the following formula: 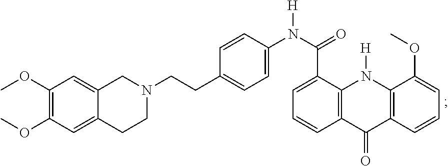 [SMILES: COc1cc2c(cc1OC)CN(CCc1ccc(NC(=O)c3cccc4c(=O)c5cccc(OC)c5[nH]c34)cc1)CC2]
or
xi) a compound of the following formula:

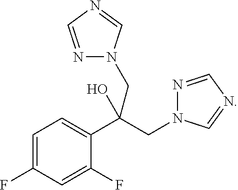 [SMILES: OC(Cn1cncn1)(Cn1cncn1)c1ccc(F)cc1F]

12. The use of a composition as claimed in claim 1 as rodenticide.

13. A pest rodent bait containing a composition as claimed in claim 1.

14. The pest rodent bait as claimed in claim 13, characterized in that each of the individual components of the composition are present at a concentration in a range from greater than 0 ppm to less than or equal to 10 000 ppm, preferably greater than 10 ppm to less than or equal to 6000 ppm, in particular greater than 50 ppm to less than or equal to 5000 ppm, relative to the total weight of the pest rodent bait.

15. The pest rodent bait as claimed in claim 12, characterized in that said bait contains a Pgp inhibitor at a concentration in a range from greater than 0 ppm to less than 6000 ppm relative to the total weight of the pest rodent bait, preferably greater than 250 ppm to less than or equal to 5500 ppm, in particular greater than 750 ppm to less than or equal to 5000.

16. The pest rodent bait as claimed in claim 12, characterized in that said bait contains a factor Xa antagonist at a concentration in a range from greater than 0 ppm to less than or equal to 8000 ppm, preferably greater than 50 ppm to less than or equal to 5000 ppm, in particular greater than 100 ppm to less than or equal to 4000 ppm.

17. The pest rodent bait as claimed in claim 12, characterized in that said bait contains a factor IIa antagonist at a concentration in a range from greater than 0 ppm to less than or equal to 8000 ppm, preferably greater than 50 ppm to less than or equal to 5000 ppm, in particular greater than 100 ppm to less than or equal to 4000 ppm.

18. A method for controlling pest rodents, wherein a pest rodent bait as claimed in claim 13 is laid.
